(19) United States
(12) Patent Application Publication
(10) Pub. No.: US 2026/0107326 A1
(43) Pub. Date: Apr. 16, 2026

(54) Methods and Apparatus for SSB-RO mapping for PRACH Transmission in SBFD Symbols

(71) Applicant: Charter Communications Operating, LLC, St. Louis, MO (US)

(72) Inventors: Mojtaba Ahmadi Almasi, Portland, OR (US); Dumitru M. Ionescu, Poway, CA (US)

(21) Appl. No.: 19/357,078

(22) Filed: Oct. 13, 2025

Related U.S. Application Data
(60) Provisional application No. 63/706,707, filed on Oct. 13, 2024.

(51) Int. Cl. H04W 74/0833; H04L 5/00; H04L 5/14

(52) U.S. Cl. CPC H04W 74/0833; H04L 5/0005; H04L 5/1469

(57) ABSTRACT

Various features relate to the use of non-sub-band full duplex (non-SBFD) slots and/or sub-band full duplex (SBFD) slots and communicating information about time-frequency structures which include such slots. A base station implements a first timing-frequency structure. The first timing-frequency structure includes a different Synchronization Signaling Block (SSB) to RACH occasion (SSB-RO) mapping for SBFD symbols and slots than is used for non-SBFD symbols and slots. The base station transmits the first timing-frequency structure information using SSB beams. The base station receives access signals, e.g. PRACH signals, from UEs on ROs indicated in the first timing-frequency structure information, and responds to the UEs, e.g., sending random access response (RAR) messages. The base station changes the implemented timing-frequency structure, to another alternative timing-frequency structure, e.g., in response to a detected change in the number of SBFD capable UEs being serviced. An SBFD capable UE uses ROs corresponding to SBFD and/or non-SBFD slots.

### RELATED APPLICATION

The present application claims the benefit of U.S. Provisional Patent Application titled “Methods and Apparatus for SSB-RO mapping for PRACH Transmission in SBFD Symbols” which was filed on Oct. 13, 2024 and assigned application Ser. No. 63/706,707 and which is hereby expressly incorporated by reference in its entirety.

### FIELD

The present application relates to communications methods and apparatus, and more particularly, to methods and apparatus for SSB-RO mapping for PRACH signal transmission in systems including SBFD symbols/slots and non-SBFD symbols/slots.

### BACKGROUND

Sub-band full duplex (SBFD) is a recent form of full duplexing that enables the simultaneous transmission of uplink (UL) and downlink (DL) signals using non-overlapping frequency resources within the confines of the same unpaired time division duplexing (TDD) carrier. Support for SBFD and inclusion of SBFD slots in timing structures used for controlling communication systems is currently under discussion. While the introduction of SBFD slots, in which a portion of the slot is used for downlink communications and another, often smaller, portion of resources in the slot are used for uplink communications, has the potential to reduce the time between opportunities for a user equipment (UE) to attempt to access a network, it introduces complexities and needs for communicating control information to allow a UE to understand which portions of a SBFD are available to the UE for access attempts and/or other uplink communications while other portions of the same slot are being used for downlink signaling.

The introduction of UEs capable of using uplink transmission opportunities in SBFD slots introduces opportunities to reduce the time required to connect to a network, e.g., by reducing the time between random access opportunities, but also creates signaling and resource utilization issues associated with SBFD utilization. The issues are complicated by the fact that many networks will likely include some UEs or other devices which are not capable of utilizing SBFD slots and/or uplink resources in such slots because they predate or do not include support for using SBFD slots and/or uplink resources in such slots. Devices which are able to take advantage of the features and/or transmission opportunities provided by SBFD slots are sometimes referred to as SBFD aware devices.

In systems which support SBFD slots, timing structures used in the communication system can include a combination of Uplink only slots, sometimes referred to as Uplink slots, in which UEs can transmit uplink signals to base stations, e.g., gNBs, Downlink only slots, sometimes referred to as Downlink slots, and SBFD slots which can include a mix of Uplink and/or Downlink resources.

UEs or other devices which do not support the use of SBFD signaling or slots, e.g., because they predate or do not support such functionality, are referred to as non-SBFD devices or non-SBFD aware devices. Accordingly, a non-SBFD aware device is a device which cannot take advantage of features made possible by SBFD functionality.

Before a UE can communicate via a network it must perform what is sometimes referred to as an initial access. Initial access is performed before data communication occurs with the UE trying to connect to a network via a base station, e.g., gNB. When performing an initial access, a UE does not know which gNB it is trying to connect to. To establish the connection, UE and gNB follow an initial access procedure.

A common initial access procedure includes two main steps: a cell search step and a random access step. During cell search, a UE receives necessary information about the gNB that it wants to connect to along with synchronization signals and information about random access channel. A base station may transmit multiple different Synchronization Signaling Block (SSB) beams. A UE may identify the strongest received SSB beam from the base station and attempt to connect with the base station using resources associated with that SSB. There is a mapping of SSBs to RACH occasions (ROs), being implemented by the base station, which is communicated to the UEs as part of part of communicated base station broadcast information. Thus, a UE intending to operate on a particular SSB beam, can identify a set of ROs, associated with the particular SSB, in an implemented timing-frequency structure, which it is allowed to use to send a PRACH signal. Typically, ROs are included and mapped to UL slots; however, the addition of SBFD slots, which include some UL time-frequency resources, provides new opportunities for RO placements within a base station implemented timing frequency structure.

Based on the above discussion, there is a need for new methods and apparatus to support SSB-RO mapping in an environment which includes SBFD slots in addition to the non-SBFD slots. It would be beneficial if at least some of these new methods and apparatus facilitated more efficient, more successful and/or lower latency random access for UEs.

### SUMMARY

Various features relate to the use of non-sub-band full duplex (non-SBFD) slots and/or sub-band full duplex (SBFD) slots and communicating information about time-frequency structures which include such slots.

In some embodiments, a base station implements a first timing-frequency structure including non-SBFD symbols and slots and SFBD symbols and slots, said first timing-frequency structure including a different SSB-RO mapping for SBFD symbols and slots than is used for non-SBFD symbols and slots. The base station transmits the first timing-frequency structure information using SSB beams. The base station receives access signals, e.g. PRACH signals, from UEs on ROs indicated in the first timing-frequency structure information, and responds to the UEs, e.g., sending random access response (RAR) messages. The base station may, and sometimes does, change the implemented timing-frequency structure, to another alternative timing-frequency structure, e.g., in response to a detected change in the number of SBFD capable UEs being serviced by the base station. The base station transmits the new timing-frequency structure information using SSB beams. The new timing-frequency structure also includes a different SSB-RO mapping for SBFD symbols and slots than is used for non-SBFD symbols and slots. Some exemplary types of differences between SBFD symbols/slots and non-SBFD symbols/slots, with regard to SSB-RO mapping, include: different frequences used for ROs, different number of SSBs mapped to an RO, different RO durations, and different association periods.

An exemplary method of operating a base station, in accordance with some embodiments, comprises: transmitting first timing-frequency structure information to be used for a first period of time, said first timing-frequency structure information indicating random access channel (RACH) Occasions (ROs) in non-SBFD symbols and SBFD symbols during which a UE can use a physical random access channel (PRACH) to send an access signal, e.g., a PRACH signal including a preamble, within a timing-frequency structure used by the base station; and monitoring for PRACH signals from UEs being communicated on ROs included in the non-SBFD and SBFD symbols.

Various embodiments and features relate to User Equipment (UE) operation. In various embodiments a UE receives base station transmitted first timing-frequency structure to be used for a first period of time where the first timing-frequency structure information indicates, e.g., timing and/or frequency location of RACH Occasions (ROs) in non-SBFD symbols (and slots) and SBFD symbols (and slots). The ROs indicate opportunities in the time-frequency structure during which a UE can use a physical random access channel (PRACH) to send an access signal, e.g., a PRACH signal including a preamble. In various embodiments the UE selects (one of the ROs indicated in the received information for use in transmitting a PRACH signal; and transmitting (1224) a PRACH signal on the selected RO. SBFD UEs, in some embodiments, selected an RO corresponding to an SBFD slot and/or symbol on at least some occasions but can and sometimes do also use ROs corresponding to non-SBFD slots. By being able to select an RO in an SBFD slot or a non-SBFD slot in the timing-frequency structure, the SBFD capable UE need not wait for an uplink only slot to occur in the timing structure to transmit a PRACH signal and can thus perform a random access operation in some cases more quickly if the UE was limited to using ROs corresponding to uplink only slots (non-SBFD).

While various features are discussed in the above summary, all features discussed above need not be supported in all embodiments and numerous variations are possible. Additional features, details and embodiments are discussed in the detailed description which follows.

### BRIEF DESCRIPTION OF THE FIGURES

FIG. 1 is a drawing of an exemplary communications system in accordance with an exemplary embodiment of the invention.

FIG. 2 is a drawing of an exemplary base station, e.g., a gNB, in accordance with an exemplary embodiment of the invention.

FIG. 3 is a drawing of an exemplary user equipment (UE), e.g., a SBFD-aware UE, in accordance with an exemplary embodiment of the invention.

FIG. 4 is a drawing of an exemplary user equipment (UE), e.g., a legacy UE which is a non SBFD-aware UE, in accordance with an exemplary embodiment of the invention.

FIG. 5 is a drawing illustrating an exemplary 4-step access method.

FIG. 6 is a drawing illustrating different SSB-RO mapping for non-SBFD symbols and SBFD symbols in accordance with an exemplary embodiment.

FIG. 7 is a drawing illustrating different SSB-RO mapping for non-SBFD symbols and SBFD symbols, in accordance with another exemplary embodiment.

FIG. 8 is a drawing illustrating different SSB-RO mapping for non-SBFD symbols and SBFD symbols, in accordance with still another exemplary embodiment.

FIG. 9 is a drawing illustrating different SSB-RO mapping for non-SBFD symbols and SBFD symbols, in accordance with yet another exemplary embodiment.

FIG. 10 is a drawing illustrating different SSB-RO mapping for non-SBFD symbols and SBFD symbols, in accordance with another exemplary embodiment.

FIG. 11A is a first part of a flowchart of an exemplary method of operating a base station, e.g., a gNB, in accordance with an exemplary embodiment.

FIG. 11B is a second part of a flowchart of an exemplary method of operating a base station, e.g., a gNB, in accordance with an exemplary embodiment.

FIG. 11 comprises the combination of FIG. 11A and FIG. 11B.

FIG. 12 is a flowchart of an exemplary method of operating a user equipment, e.g., a SBFD capable UE, in accordance with an exemplary embodiment.

### DETAILED DESCRIPTION

Before going through the details of various embodiments and features of the invention, some terminology will first be explained.

In various embodiments, there are 14 Orthogonal Frequency Division Multiplexing (OFDM) symbols per slot.

In an Uplink (UL) slot: all the OFDM symbols in time domain and all the resource blocks (RBs) in frequency domain are allocated for UL direction.

In a Downlink (DL) slot all the OFDM symbols in time domain and all the resource blocks (RBs) in frequency domain are allocated for DL direction.

In an UL symbol: all the RBs are allocated for UL direction and there is only one OFDM symbol in time domain.

In a DL symbol: all the RBs are allocated for DL direction and there is only one OFDM symbol in time domain.

A sub-band full duplex (SBFD) slot is a slot used for downlink (DL), but in the OFDM symbols within the SBFD slot some of the RBs (e.g., 20% of the RBs) are allocated for UL transmission. Thus, an SBFD slot and/or SB symbol can support some uplink transmission but normally far less than an UL slot.

SBFD symbol: This is a symbol that occupies one OFDM symbol, but some of the RBs are allocated for UL transmission with others allocated for DL transmission.

A non-SBFD slot and/or symbol is a slot or symbol where the RBs are allocated for UL or DL transmissions but not both UL and DL in the same slot/symbol.

Before a user equipment (UE) transmits/receives data or control signaling from a gNB, it will perform an initial access using an access channel. The channel which is used is referred to as an initial random access channel (RACH). There are two different RACH methods which can be used with one method being a 4 step method and the other being a 2-step method. The particular steps depend on the mode in which the UE is operating when attempting a RACH procedure. Accordingly, there is a 4-step contention-based random access (CBRA) and ii) a 2-step CBRA for use when UE is in idle mode. Also, there is 4-step contention-free random access (CFRA) and 2-step CFRA which can be used by a UE when the UE is in RRC-connected mode.

Various embodiments and features of the invention focus on a 4-step CBRA, although one of the proposed Synchronization Signal Block-RACH Occasion (SSB-RO) mappings can be applied to the other random access methods.

These 4 steps are as follows:

MSG1-UE transmits a Physical Random Access Channe (PRACH) signal toward gNB. The signal is a Zadoff-Chu sequence constructed from a preamble. To transmit the PRACH, UE needs to find a proper RO. This is done through SSB-RO mapping obtained from the SSB/PBCH and System Information Block 1 (SIB1) signaling before Message 1 (MSG1).

MSG2-gNB detects the PRACH and preamble. Then, it sends a Downlink Control Information (DCI) and Physical Downlink Shared Channel (PDSCH). The Cyclic Redundancy Check (CRC) in the DCI is scrambled by Random Access-Radio Network Temporary Identifier (RA-RNTI) which is obtained from RO's time and frequency information. The PDSCH, contains UL grant, Temporary Cell-Radio Network Temporary Identifier (TC-RNTI), etc.

MSG3-UE transmits its ID scrambled by TC-RNTI.

MSG4-gNB sends a DCI and PDSCH. The PDSCH verifies that gNB has received the MSG3.

Finally, UE transmits HARQ-ACK through Physical Uplink Control Channel (PUCCH) to inform the gNB that the UE has received the MSG4.

In legacy SSB-RO mapping, ROs are located in non-SBFD symbols (only UL symbols/slots). In order to reduce latency and/or PRACH collision, SBFD symbols/slots can also be allocated for PRACH transmission (e.g., RO). However, the frequency resources (i.e., RBs) and the time duration (i.e., OFDM symbols) in SBFD symbols/slots could be, and in some embodiments, are different from that of the non-SBFD symbols. For instance, the number of RBs in SBFD symbols is usually limited to 50 RBs. However, in a non-SBFD symbol (i.e., an UL symbol), the number of RBs allocated for ROs can be up to 96 RBs. Also, the starting RBs in SBFD and non-SBFD symbols are different. To capture/take advantage of the differences, in some embodiments implemented in accordance with features of the invention, the SSB-RO mapping for SBFD symbols/slots is designed independently to assist UEs transmit their PRACH earlier and/or with lower probability of collision compared to the legacy UEs transmitting their PRACH within non-SBFD symbols/slots. To this end, in one of the SSB-RO mapping schemes that is sometimes used in accordance with the invention, the periodicity is shorter than the SSB-RO mapping for non-SBFD symbols/slots since there is a larger and/or sufficient number of ROs available in SBFD symbols/slots as compared to non-SBFD slots. In another scheme, the periodicity of ROs in non-SBFD and SBFD slots remains the same, but multiple SSBs are mapped to one RO. Further, in the third scheme, a shorter PRACH format is chosen such that multiple ROs are available within a single slot. Finally, in the fourth scheme, the periodicity is longer than that of the non-SBFD, but the same number of SSBs and preambles are mapped to ROs for both SBFD and non-SBFD symbols/slots.

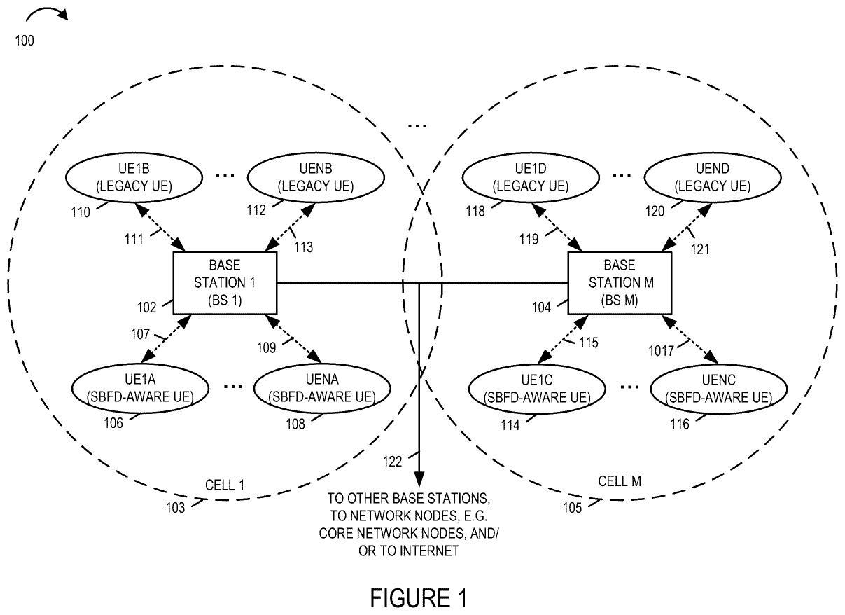

FIG. 1 is a drawing of an exemplary communications system 100 in accordance with an exemplary embodiment. Exemplary communications system 100 includes a plurality of base stations (base station 1 102, . . . , base station M 104) coupled together, to network nodes, e.g., to 5G core network nodes, and/or to the Internet via communications backhaul link(s) 122. Exemplary communications system 100 further includes a plurality of user equipments (UEs) (UE1A 106, . . . , UENA 108, UE1B 110, . . . , UENB 112, UE1C 1014, . . . , UENC 116, UE1D 118, . . . , UEND 120). At least some of the UEs are mobile wireless devices which may move throughout system 100 and be connected to different base stations at different time. Some of the UEs are SBFD-aware UEs, while other UEs are legacy UEs. UE1A 106, UENA 108, UE1C 114, and UENC 116 are SBFD-aware UEs. UE1B 100, UENB 112, UE1D 118, and UEND 120 are legacy UEs.

Base station 1 (BS 1) 102 has a corresponding cellular coverage area 103. UEs (106, 108, 100 and 112 are currently located within cellular coverage area 103. UE1A 106 is coupled to BS 1 102 via wireless connection 107. UENA 108 is coupled to BS 1 102 via wireless connection 109. UE1B 110 is coupled to BS 1 102 via wireless connection 111. UENB 112 is coupled to BS 1 102 via wireless connection 113.

Base station M (BS M) 104 has a corresponding cellular coverage area 105. UEs (114, 116, 108 and 120 are currently located within cellular coverage area 105. UE1C 114 is coupled to BS M 104 via wireless connection 115. UENC 116 is coupled to BS M 104 via wireless connection 117. UE1D 108 is coupled to BS M 104 via wireless connection 119. UEND 120 is coupled to BS M 104 via wireless connection 121.

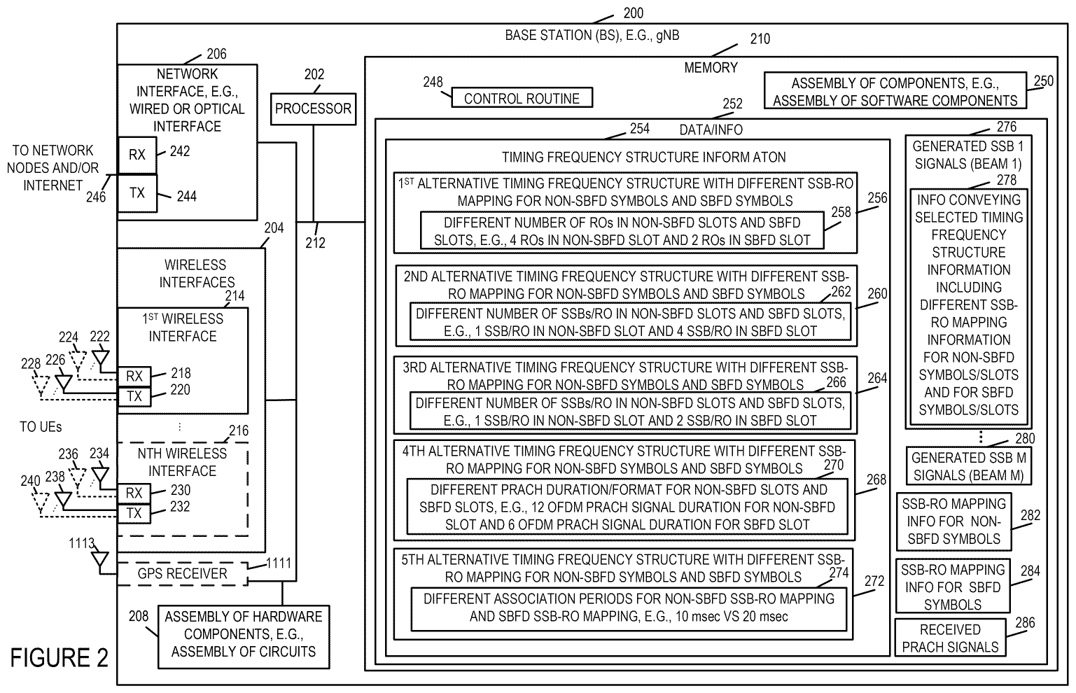

FIG. 2 is a drawing of an exemplary base station 2200, e.g., a gNB, in accordance with an exemplary embodiment. Exemplary base station 200 is, e.g., BS 1 102 or BS M 104 of system 100 of FIG. 1. Exemplary base station 200 includes a processor 202, e.g., a CPU, wireless interfaces 204, a network interface 206, an assembly of hardware components 208, e.g., an assembly of circuits, and memory 210 coupled together via bus 212 over which the various elements may interchange data and information. In some embodiments, base station 200 further includes a GPS receiver 211 coupled to bus 212.

Wireless interfaces 204 includes one or more wireless interfaces (1st wireless interface 214, . . . , Nth wireless interface 216). 1st wireless interface 214 includes wireless receiver 218 and wireless transmitter 220. Wireless receiver 218 is coupled to one or more receiver antennas (222, . . . , 224) via which the base station 200 receives wireless uplink signals from UEs. Wireless transmitter 220 is coupled to one or more transmit antennas (226, . . . , 228) via which the base station 200 transmits wireless downlink signals to UEs. In some embodiments one or more antennas are used by both the receiver 218 and transmitter 220. Nth wireless interface 216 includes wireless receiver 230 and wireless transmitter 232. Wireless receiver 230 is coupled to one or more receive antennas (234, . . . , 236) via which the base station 200 receives wireless uplink signals from UEs. Wireless transmitter 232 is coupled to one or more transmit antennas (238, . . . , 240) via which the base station 200 transmits wireless downlink signals to UEs. In some embodiments one or more antennas are used by both the receiver 230 and transmitter 232. In some embodiments different wireless interfaces correspond to different communications bands, different spectrum, and/or different communications protocols.

Network interface 206, e.g., a wired or optical interface, includes receiver 242, transmitter 244 and connector 246. Network interface 206 couples the base station 200 to network nodes, e.g., other base stations, core network nodes, e.g., 5G core network nodes, and/or the Internet.

GPS receiver 211 is coupled to GPS receive antenna 213. GPS signals, received via GPS receive antenna 213, are processed by the GPS receiver 211 to determine time, position, e.g. latitude, longitude and altitude, and velocity information. In some embodiments the GPS receiver 211 is used to facilitate a precise placement of the base station 200, e.g., as part of an installation process.

Memory 210 includes a control routine 248, an assembly of components 250 and data/information 252. Control routine 248 includes instructions which when executed by processor 202 control the base station 200 to implement basic operational functions, e.g., read memory, write to memory, control an interface, load a program, subroutine, or app, etc. Assembly of components 250, e.g., an assembly of software components, e.g., routines, subroutines, applications, etc., includes, e.g., code, e.g., machine executable instructions, which when executed by processor 202, controls the base station 200 to implement steps of a method in accordance with the present invention.

Data/information 252 includes timing-frequency structure information 254. Timing-frequency structure information 254 includes a plurality of alternative sets of timing frequency structure information with different SSB-RO mapping for non-SBFD symbols and SBFD symbols. Timing frequency structure information 254 includes 1st alternative timing frequency structure information 256 for a first timing frequency structure having different SSB-RO mapping for non-SBFD symbols and SBFD symbols, 2nd alternative timing frequency structure information 260, for a second timing frequency structure having different SSB-RO mapping for non-SBFD symbols and SBFD symbols, 3rd alternative timing frequency structure information 264 for a third timing frequency structure having different SSB-RO mapping for non-SBFD symbols and SBFD symbols, 4th alternative timing frequency structure information 268 for a fourth timing frequency structure having different SSB-RO mapping for non-SBFD symbols and SBFD symbols, and 5th timing frequency structure information 272 for a fifth timing frequency structure having different SSB-RO mapping for non-SBFD symbols and SBFD symbols.

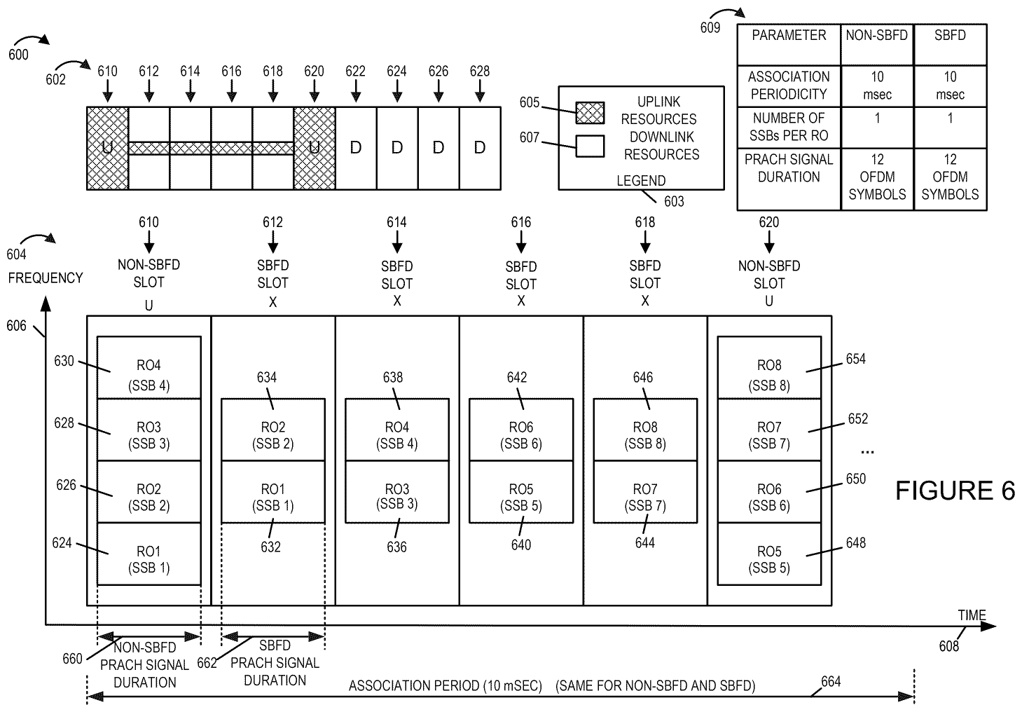

1st alternative timing frequency structure information 256 includes information 258 which specifies and/or is used to implement a different number of ROs in non-SBFD slots and SBFD slots, e.g., 4 ROs in non-SBFD slots and 2 ROs in SBFD slots. FIG. 6 illustrates an exemplary 1st alternative timing frequency structure in accordance with information 256.

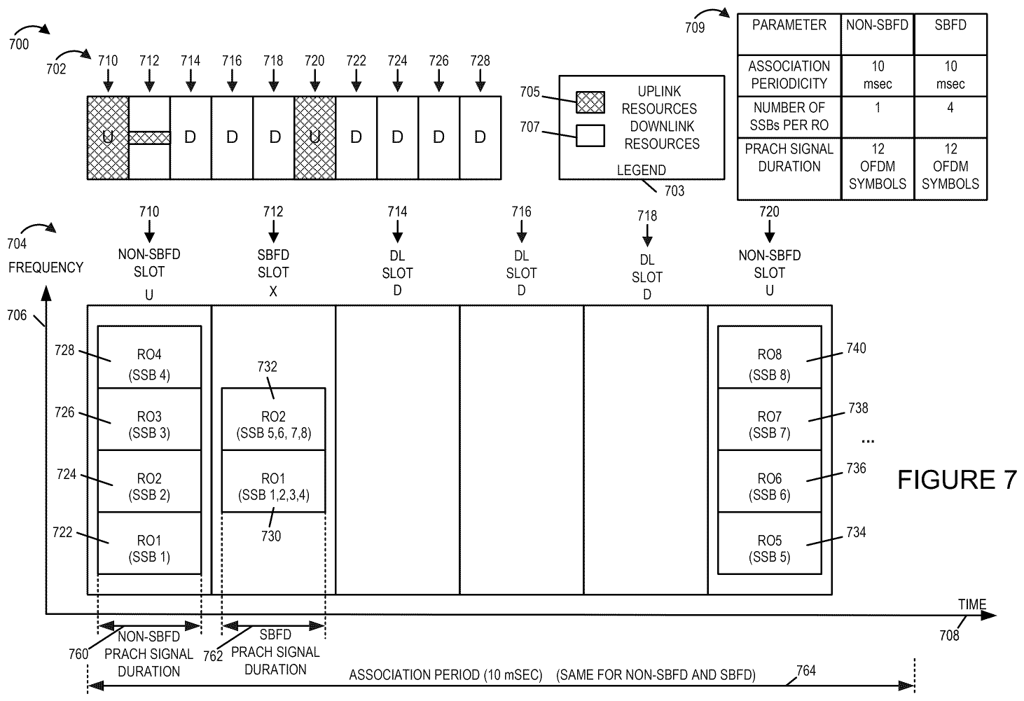

2nd alternative timing frequency structure information 260 includes information 262 which specifies and/or is used to implement a different number of SSBs/RO in non-SBFD slots and SBFD slots, e.g., 1 SSB/RO in non-SBFD slots and 4 SSB/RO in SBFD slots. FIG. 7 illustrates an exemplary 2nd alternative timing frequency structure in accordance with information 260.

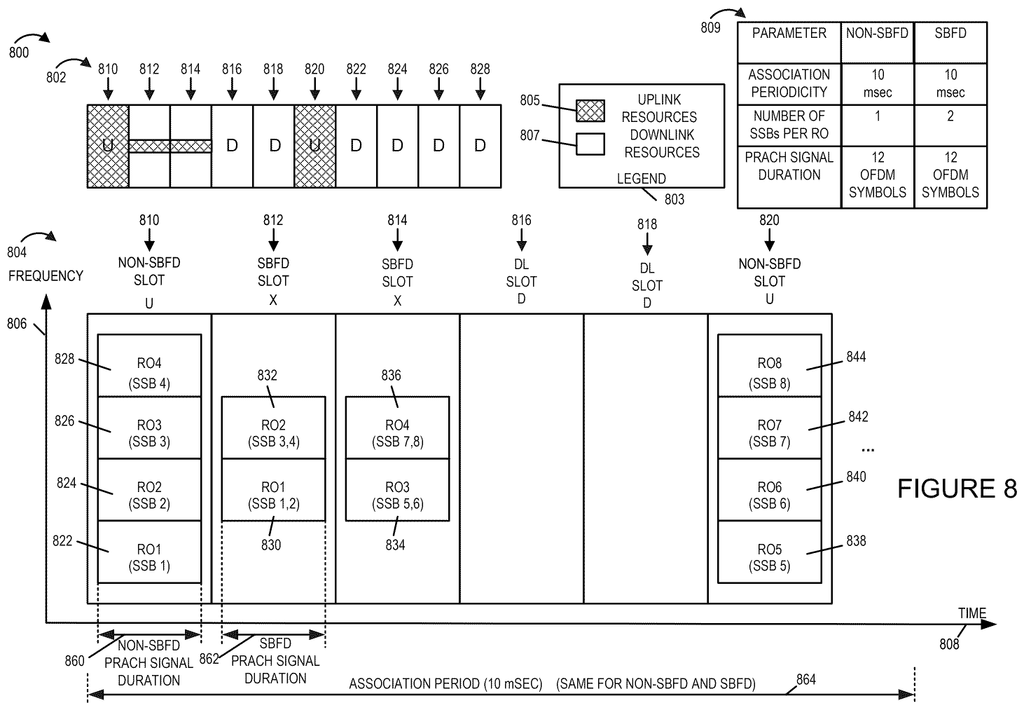

3rd alternative timing frequency structure information 264 includes information 266 which specifies and/or is used to implement a different number of SSBs/RO in non-SBFD slots and SBFD slots, e.g., 1 SSB/RO in non-SBFD slots and 2 SSB/RO in SBFD slots. FIG. 8 illustrates an exemplary 3rd alternative timing frequency structure in accordance with information 264. It may also be observed that the timing-frequency structure of FIG. 8 includes more SBFD slots than the timing frequency structure of FIG. 7.

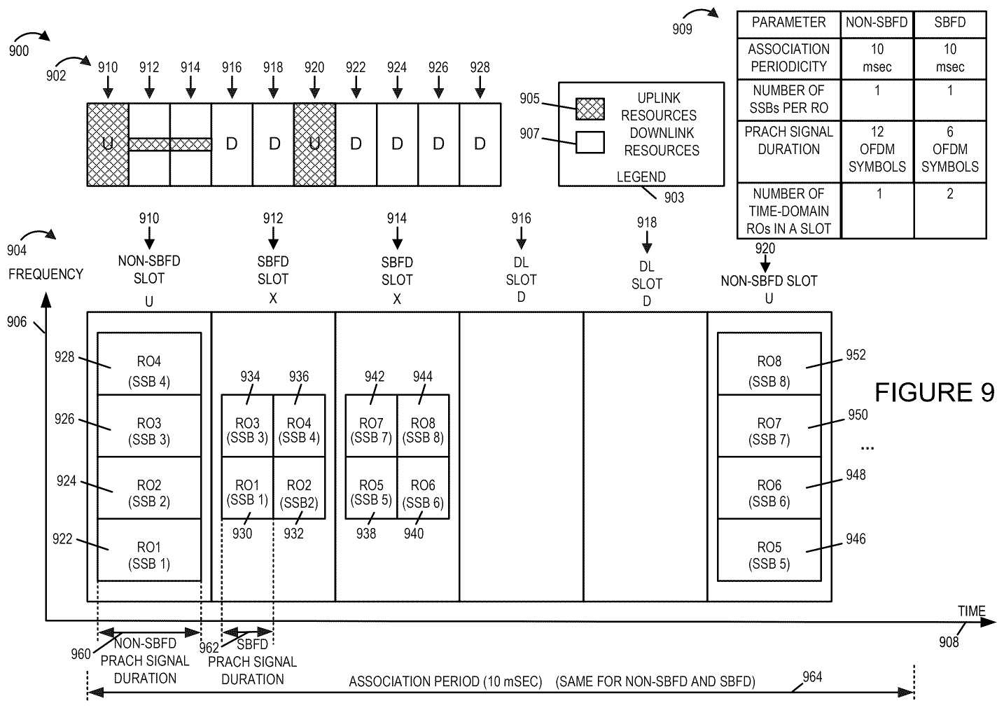

4th alternative timing frequency structure information 268 includes information 270 which specifies and/or is used to implement a different PRACH duration/format for non-SBFD slots and SBFD slots, e.g., a 12 OFDM PRACH signal duration for non-SBFD slots and 16 OFDM PRACH signal duration for SBFD slots. FIG. 9 illustrates an exemplary 4th alternative timing frequency structure in accordance with information 268.

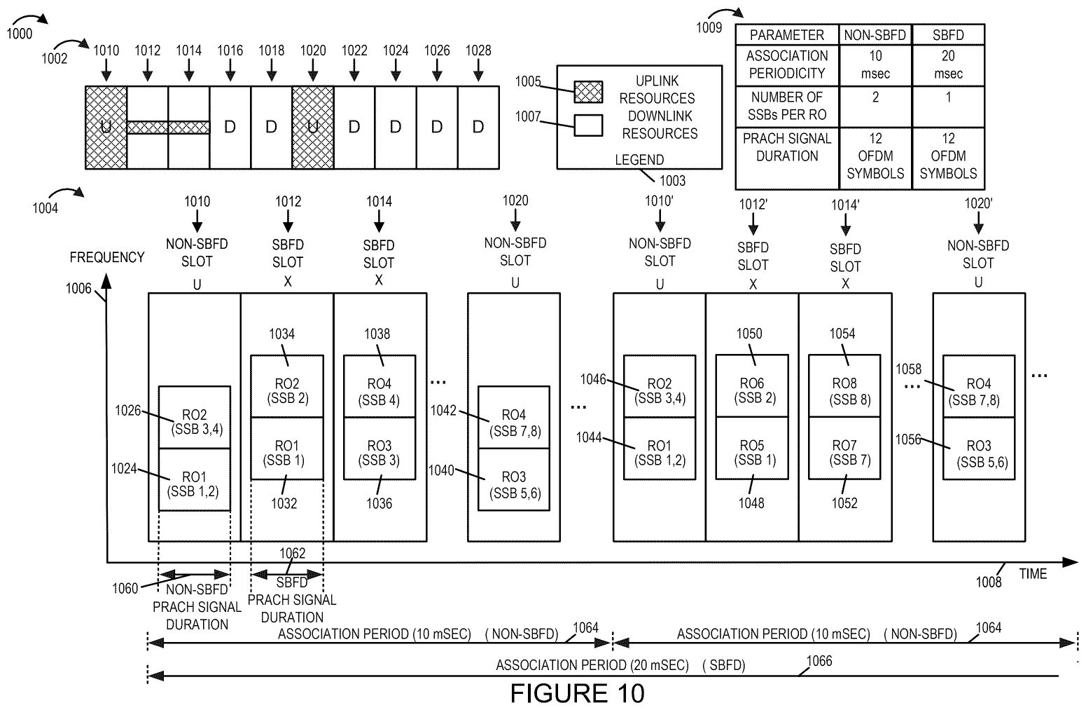

5th alternative timing frequency structure information 272 includes information 274 which specifies and/or is used to implement different association periods for non-SBFD SSB-RO mapping and SBFD SSB-RO mapping, e.g. 10 msec vs 20 msec. FIG. 10 illustrates an exemplary 5th alternative timing frequency structure in accordance with information 272.

At different times and/or under different conditions, e.g., different traffic loading conditions and/or different number of UEs requiring service, a different one of the alternative timing frequency structures may be selected and implemented by the base station, e.g., with the base station transmitting different information in the SSBs.

Data/information 252 further includes generated signals which are communicated over SSB beams (generated SSB 1 signals (beam 1) 276, . . . , generated SSB M signals (beam M) 280). SSB 1 signals 276 includes information 278 conveying selected timing frequency structure information including different SSB-RO mapping information for non-SBFD symbols/slots and SBFD symbols/slots. The selected timing-frequency structure, being implemented by base station 200 includes non-SBFD slots, each non-SBFD slot including one or more non-SBFD symbols and SBFD slots, each SBFD slot including one or more SBFD symbols. The selected timing-frequency structure being implemented by the base station 200 specifies a particular set of ROs corresponding to each of the SSBs.

Data/information 252 further includes SSB-RO mapping information for non-SBFD symbols 282, corresponding to the selected timing frequency structure, which is being implemented, and SSB-RO mapping information for SBFD symbols 284, corresponding to the selected timing frequency structure which is being implemented. Data/information 252 further includes received PRACH signals 286, including PRACH signals received on ROs in non-SBFD slots and PRACH signals received on ROs in SBFD slots.

SSB 1 information includes, in some embodiments, a generated SIB1including a msg1-FrequencyStart. SSB 1 information includes, in some embodiments, a generated SIB1 including a msg1-FDM-SBFD-r19 and a msg1-FrequencyStartSBFD-r19. SSB 1 information 260 includes, in some embodiments, a generated SIB1 including a Msg1-RO-FrequencyOffsetSBFD-r19. SSB 1 information 260 includes, in some embodiments, a generated SIB1 including a ra-RO-FrequencyOffset SBFD-r19 and a ra-RO-ScalingFactorSFBD-r19.

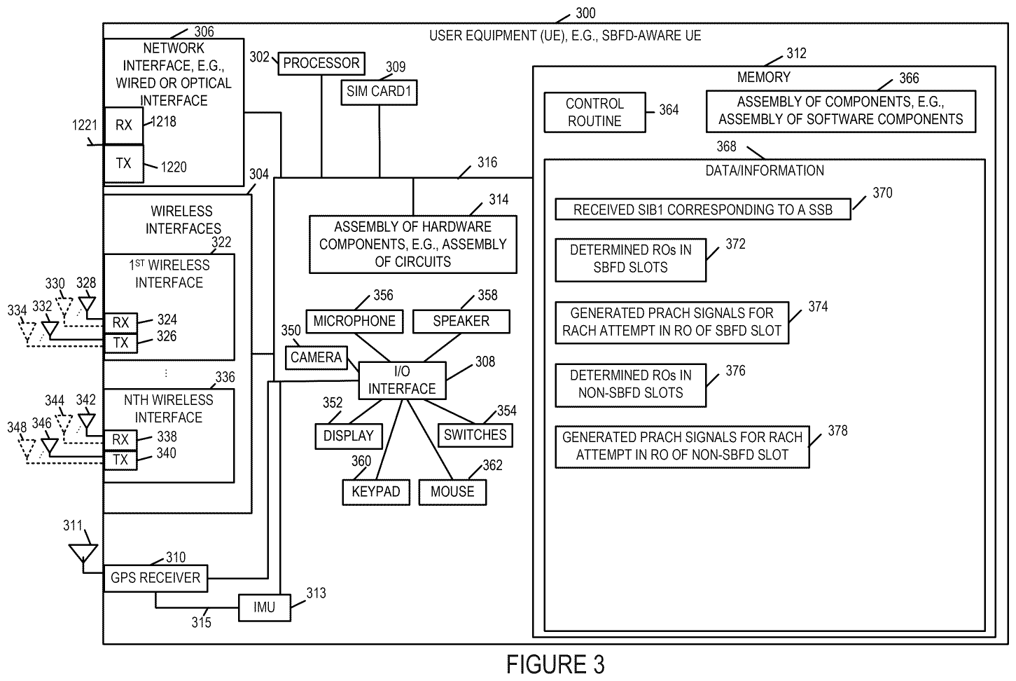

FIG. 3 is a drawing of an exemplary user equipment (UE) 300, e.g., a SBFD-aware UE, in accordance with an exemplary embodiment. Exemplary UE 300 of FIG. 3 is, e.g., any of UEs (106, 108, 114, 116) of system 100 of FIG. 1.

Exemplary UE 300 includes a processor 302, e.g., a CPU, wireless interfaces 304, a network interface 306, e.g., a wired or optical interface, I/O interface 308, GPS receiver 310, inertial measurement unit (IMU) 313, and assembly of hardware components 314, e.g., an assembly of circuits, coupled together via bus 316 over which the various elements may interchange data and information. In various embodiments, UE 300 further includes SIM card 1 309 coupled to bus 316.

Wireless interfaces 304 includes a plurality of wireless interfaces (1st wireless interface 322, . . . , Nth wireless interface 336). 1st wireless interface 322 includes wireless receiver 324 and wireless transmitter 326. Wireless receiver 324 is coupled to one or more receiver antennas (328, . . . , 330) via which the UE 300 receives wireless downlink signals from base stations. Wireless transmitter 326 is coupled to one or more transmit antennas (332, . . . , 334) via which the UE 300 transmits wireless uplink signals to base stations. In some embodiments one or more antennas are used by both the receiver 324 and transmitter 326. Nth wireless interface 336 includes wireless receiver 338 and wireless transmitter 340. Wireless receiver 338 is coupled to one or more receive antennas (342, . . . , 344) via which the UE 300 receives wireless downlink signals from base stations. Wireless transmitter 340 is coupled to one or more transmit antennas (346, . . . , 348) via which the UE 300 transmits wireless uplink signals to base stations. In some embodiments one or more antennas are used by both the receiver 338 and transmitter 340. In some embodiments different wireless interfaces correspond to different communications bands, different spectrum, and/or different communications protocols.

Network interface 306, e.g., a wired or optical interface, includes receiver 318, transmitter 320 and connector 321. Network interface 306 may, and sometimes does, couple UE 300 to base stations, network nodes and/or the Internet, e.g., when the UE 300 is stationary and located at a site with a wireline and/or optical connection.

GPS receiver 310 is coupled to GPS antenna 311. GPS receiver 310 is further coupled to IMU 313, e.g., an IMU on a chip including gyroscopes and accelerometers. GPS signals, received via GPS receive antenna 311, are processed by the GPS receiver 310 to determine time, position, e.g. latitude, longitude and altitude, and velocity information of UE 300. In some embodiments, information from IMU 313, e.g., accelerometer and/or gyroscopes measurements over time, are used, in conjunction with or in place of GPS measurements to determine position, e.g. latitude, longitude and altitude, and velocity information of UE 300. SIM card 1 309 includes information corresponding to a first communications network operator to which the owner of UE 300 is a subscriber.

UE 300 further includes a plurality of I/O devices (camera 350, display 352, e.g., a touch screen display, switches 354, microphone 356, speaker 358, keypad 360 and mouse 362) coupled to I/O interface 308, which couples the various I/O devices to other elements of the UE 300 via bus 316.

Memory 312 includes a control routine 364, an assembly of components 366, e.g., an assembly of software components, and data/information 368. Control routine 364 includes instructions which when executed by processor 302 control the UE 300 to implement basic operational functions, e.g., read memory, write to memory, control an interface, load a program, subroutine, or app, etc. Assembly of components 366, e.g., an assembly of software components, e.g., routines, subroutines, applications, etc., includes, e.g., code, e.g., machine executable instructions, which when executed by processor 302, controls the UE 300 to implement steps of a method in accordance with an exemplary embodiment of the present invention. Data/information 368 includes a received SIB1 corresponding to a SSB 370, determined ROs in SBFD slots 372, which may be used by the UE 300, determined ROs in non-SBFD slots 376, which may be used by UE 300, generated PRACH signals 374 for a RACH attempt in RACH occasion (RO) of SBFD slot, and generated PRACH signals 378 for a RACH attempt in RACH occasion (RO) of a non-SBFD slot.

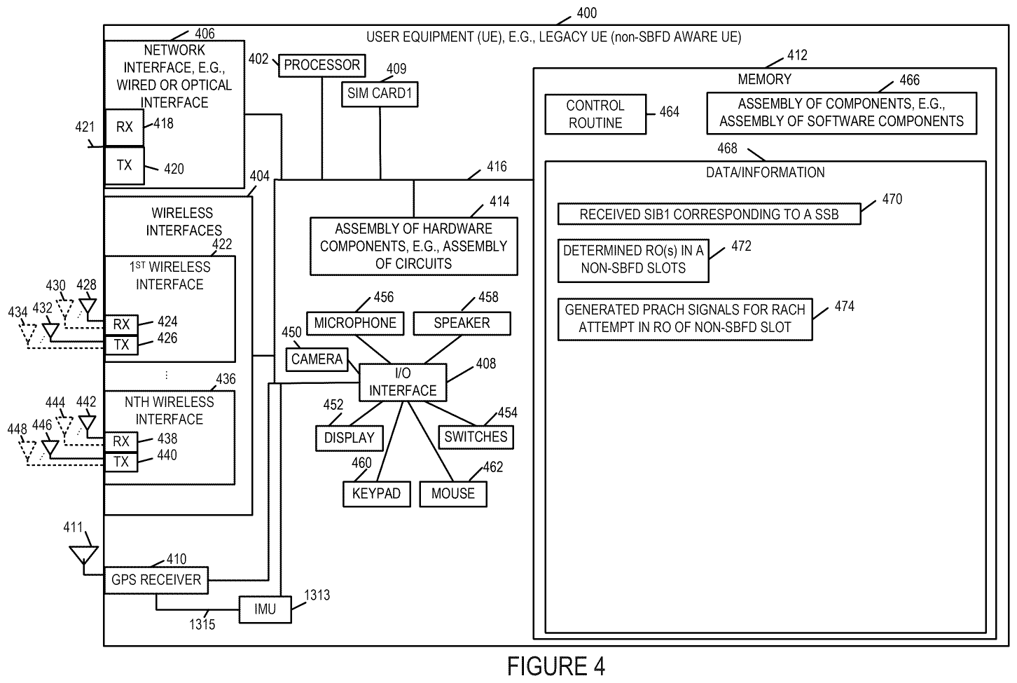

FIG. 4 is a drawing of an exemplary user equipment (UE) 400, e.g., a legacy UE, in accordance with an exemplary embodiment. Exemplary UE 400 of FIG. 4 is, e.g., any of UEs (110, 112, 118, 120) of system 100 of FIG. 1.

Exemplary UE 400 includes a processor 402, e.g., a CPU, wireless interfaces 404, a network interface 406, e.g., a wired or optical interface, I/O interface 408, GPS receiver 410, inertial measurement unit (IMU) 413, and assembly of hardware components 414, e.g., an assembly of circuits, coupled together via bus 416 over which the various elements may interchange data and information. In various embodiments, UE 400 further includes SIM card 1 409 coupled to bus 416.

Wireless interfaces 404 includes a plurality of wireless interfaces (1st wireless interface 422, . . . , Nth wireless interface 436). 1st wireless interface 422 includes wireless receiver 424 and wireless transmitter 426. Wireless receiver 424 is coupled to one or more receiver antennas (428, . . . , 430) via which the UE 400 receives wireless downlink signals from base stations. Wireless transmitter 426 is coupled to one or more transmit antennas (432, . . . , 434) via which the UE 400 transmits wireless uplink signals to base stations. In some embodiments one or more antennas are used by both the receiver 424 and transmitter 426. Nth wireless interface 436 includes wireless receiver 438 and wireless transmitter 440. Wireless receiver 438 is coupled to one or more receive antennas (442, . . . , 444) via which the UE 400 receives wireless downlink signals from base stations. Wireless transmitter 440 is coupled to one or more transmit antennas (446, . . . , 448) via which the UE 300 transmits wireless uplink signals to base stations. In some embodiments one or more antennas are used by both the receiver 438 and transmitter 440. In some embodiments different wireless interfaces correspond to different communications bands, different spectrum, and/or different communications protocols.

Network interface 406, e.g., a wired or optical interface, includes receiver 418, transmitter 420 and connector 421. Network interface 406 may, and sometimes does, couple UE 400 to base stations, network nodes and/or the Internet, e.g., when the UE 400 is stationary and located at a site with a wireline and/or optical connection.

GPS receiver 410 is coupled to GPS antenna 411. GPS receiver 410 is further coupled to IMU 413, e.g., an IMU on a chip including gyroscopes and accelerometers. GPS signals, received via GPS receive antenna 411, are processed by the GPS receiver 410 to determine time, position, e.g. latitude, longitude and altitude, and velocity information of UE 400. In some embodiments, information from IMU 413, e.g., accelerometer and/or gyroscopes measurements over time, are used, in conjunction with or in place of GPS measurements to determine position, e.g. latitude, longitude and altitude, and velocity information of UE 400. SIM card 1 409 includes information corresponding to a first communications network operator to which the owner of UE 400 is a subscriber.

UE 400 further includes a plurality of I/O devices (camera 450, display 452, e.g., a touch screen display, switches 454, microphone 456, speaker 458, keypad 460 and mouse 462) coupled to I/O interface 408, which couples the various I/O devices to other elements of the UE 400 via bus 416.

Memory 412 includes a control routine 464, an assembly of components 466, e.g., an assembly of software components, and data/information 468. Control routine 464 includes instructions which when executed by processor 402 control the UE 400 to implement basic operational functions, e.g., read memory, write to memory, control an interface, load a program, subroutine, or app, etc. Assembly of components 466, e.g., an assembly of software components, e.g., routines, subroutines, applications, etc., includes, e.g., code, e.g., machine executable instructions, which when executed by processor 402, controls the UE 400 to implement steps of a method in accordance with an exemplary embodiment of the present invention. Data/information 468 includes a received SIB1 corresponding to a SSB 470, determined ROs in non-SBFD slots 472, which may be used by UE 400, and generated PRACH signals 474 for a RACH attempt in RACH occasion (RO) of a non-SBFD slot.

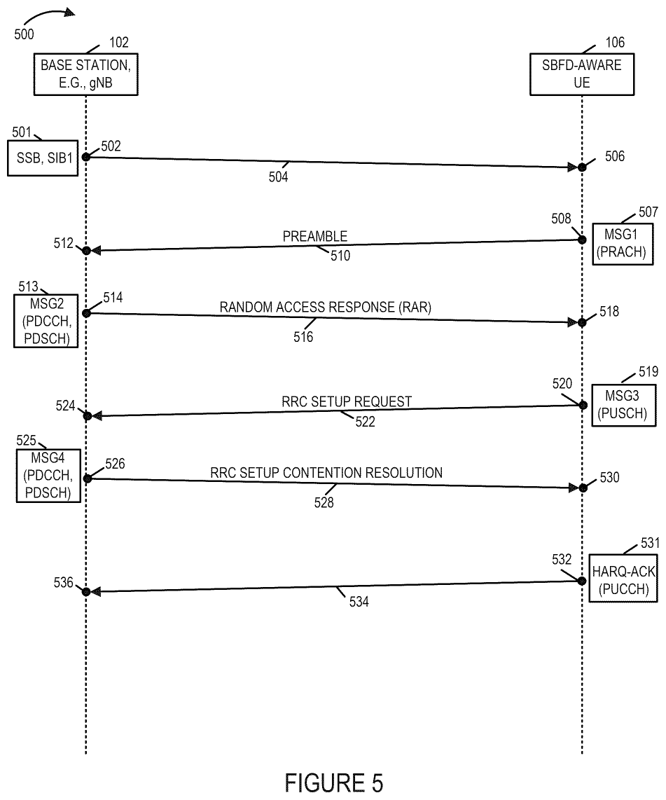

FIG. 5 is a signaling diagram 500 illustrating a 4-step RACH access method, being performed between exemplary base station 102, e.g., a gNB, and exemplary SBFD-aware UE 106, in accordance with an exemplary embodiment. Information box 501 indicates that that base station 102 will broadcast Synchronization Signaling Block (SSB) beams conveying System Information Block (SIB) information including System Information Block 1 (SIB1) information. The SIB1 information includes information identifying the timing-frequency structure being implemented by the base station 102, said timing-frequency structure including SBFD slots and non-SBFD slots. In step 502 base station 102 generates and transmits, e.g., broadcasts, SSB beam(s) 504 conveying System Information Block Information including SIB1 information. In step 506, UE 106 detects and receives one or more SSB beams, measures a received signal power, e.g. a DMRS-RSRP corresponding to each of the received SSB beams, identifies a strongest received SSB beam based on RSRP, and recovers the SIB1 information corresponding to the strongest detected SSB.

Information box 507 indicates that UE 106 will send a message 1 (msg1) using PRACH resources, as part of the 4-step access method. In step 508 UE 106 generates and sends a msg1 signal 510 which includes a preamble on RACH Occasion (RO) time-frequency resources of the PRACH, which UE 106 is allowed to use, to base station 102, which receives the PRACH signal 510 successfully in step 512 and recovers the communicated information.

Information box 513 indicates that the base station 102 will send a msg2 using PDCCH and PDSCH resources, as part of the 4-step access method. In step 514, in response to the successfully received PRACH signal from UE 106, base station 102 generates and sends a msg2 signal 516, which includes a random access response (RAR) message, to UE 106, which receives the RAR message in step 518 and recovers the communicated information, e.g., information indicating: PUSCH channel resources, e.g., one or more PUSCH occasions (POs), which have been assigned (scheduled) to be used by the UE 106, a PUSCH signal transmission power level, a frequency hopping flag, and a number of repetitions.

Information box 519 indicates that UE 106 will send a msg3 522 using PUSCH resources, as part of the 4-step access method. In step 520 UE 106 generates and sends a msg3 PUSCH signal transmission, which is a RRC setup request message 522, to base station 102 in accordance with the information in the received RAR 516, e.g., the UE 106 uses the indicated scheduled time-frequency PUSCH resources to send msg3, transmits msg3 at the indicated transmission power level and sends the indicated number of PUSCH signal repetitions. In step 524, base station 102 receives the RRC setup request message 522 and recovers the communicated information.

Information box 525 indicates that base station 102 will send a msg4 using PDCCH and PDSCH resources, as part of the 4-step access method. In step 526 base station 102 generates and sends msg4, which is a RRC setup contention resolution message 528, to UE 106, which receives the message 528 in step 530 and recovers the communicated information.

Information box 531 indicates that UE 106 will send a HARQ-ACK to base station 102 using PUCCH resources, as part of the 4-step access method. In step 532 UE 106 generates and sends the HARQ-ACK 534 to base station 102, which receives the HARQ-ACK 524 in step 536.

FIG. 6 is a drawing 600 illustrating different SSB-RO mapping for non-SBFD symbols and SBFD symbols in accordance with an exemplary embodiment. Drawing 600 includes a drawing 602 illustrating an exemplary mapping of slots in accordance with an exemplary timing-frequency structure, the slots including uplink slots, downlink slots, an SBFD slots, a corresponding legend 603, an exemplary time-frequency plot 604 illustrating RO to SSB mapping for exemplary non-SBFD slots and exemplary SBFD slots, in accordance with the exemplary embodiment.

Drawing 602 illustrates an exemplary sequence of slots including: uplink (U) slot 610, SBFD slot 612, SBFD slot 614, SBFD slot 616, SBFD slot 618, uplink (U) slot 620, downlink (D) slot 622, downlink (D) slot 624, downlink (D) slot 626 and downlink (D) slot 628. Legend 603 indicates that crosshatch shading, as shown in sample box 605, is used to indicate uplink resources within the sequence of slots of drawing 602, and no shading, as shown in sample box 607, is used to indicate downlink resources within the sequence of slots of drawing 602. It may be observed that the majority of resources within a SBFD slot are designated to be downlink resources, while a minority of the resources of the uplink slot are designated to be used as uplink resources.

Time-frequency plot 604 includes a vertical axis 606 representing frequency and a horizontal axis 608 representing time. Non-SBFD slot 610, which is an uplink slot, designated with a U, includes four RACH Occasions (ROs), which are: RO1 624, RO2 626, RO3 628, RO4 630. SSB1 is mapped to RO1 624 in non-SBFD slot 610. SSB2 is mapped to RO2 626 in non-SBFD slot 610. SSB3 is mapped to RO3 628 in non-SBFD slot 610. SSB4 is mapped to RO4 630 in non-SBFD slot 610.

SBFD slot 612, designated with a X, includes two RACH Occasions (ROs), which are: RO1 632 and RO2 634. SSB 1 is mapped to RO1 632 in SBFD slot 612. SSB 2 is mapped to RO2 634 in SBFD slot 610.

SBFD slot 614, designated with a X, includes two RACH Occasions (ROs), which are: RO3 636 and RO4 638. SSB 3 is mapped to RO3 632 in SBFD slot 614. SSB 4 is mapped to RO4 638 in SBFD slot 614.

SBFD slot 616, designated with a X, includes two RACH Occasions (ROs), which are: RO5 640 and RO6 642. SSB 5 is mapped to RO5 640 in SBFD slot 616. SSB 6 is mapped to RO6 642 in SBFD slot 616.

SBFD slot 618, designated with a X, includes two RACH Occasions (ROs), which are: RO7 644 and RO8 646. SSB 7 is mapped to RO7 644 in SBFD slot 618. SSB 8 is mapped to RO8 646 in SBFD slot 618.

Non-SBFD slot 620, which is an uplink slot, designated with a U, includes four RACH Occasions (ROs), which are: RO5 648, RO6 650, RO7 652, RO8 654. SSB 5 is mapped to RO5 648 in non-SBFD slot 620. SSB 6 is mapped to RO6 650 in non-SBFD slot 620. SSB 7 is mapped to RO7 652 in non-SBFD slot 620. SSB 8 is mapped to RO8 654 in non-SBFD slot 620.

Exemplary non-SBFD PRACH signal duration 660, which is, e.g., 12 OFDM symbols duration in time for a 14 symbol length slot, is also shown in FIG. 6. Exemplary SBFD PRACH signal duration 662, which is, e.g., 12 OFDM symbols duration in time for a 14 symbol length slot, is also shown in FIG. 6. The association period 664, for SSB to RO mapping for both non-SBFD type symbols/slots and SBFD type symbols/slots is 10 msec.

Table 609 is comparison table comparing non-SBFD symbols/slot to SBFD symbols/slots, with regard to SSB-RO mapping of the example shown in drawing 604. Association periodicity is the same value, which is 10 msec, for both non-SBFD type and SBFD type. The number of SSB per RO is the same value, which is 1, for both non-SBFD type and SBFD type. The PRACH signal duration is the same value, which is 12 OFDM symbols, in a slot size of 14 OFDM symbols, for both non-SBFD type and SBFD type.

It may also be observed that there are a different number of ROs in non-SBFD slots as compared to SBFD slots; each of the non-SBFD slots (610, 620) includes 4 ROs, while each of the SBFD slots (612, 614) includes 2 ROs. It may also be observed that each RO is the same size, in terms of time-frequency resources, irrespective of whether the RO is within a non-SBFD slot or a SBFD slot.

FIG. 7 is a drawing 700 illustrating different SSB-RO mapping for non-SBFD symbols and SBFD symbols, in accordance with another exemplary embodiment. Drawing 700 includes a drawing 702 illustrating an exemplary mapping of slots in accordance with an exemplary timing-frequency structure, the slots including uplink slots, downlink slots, an SBFD slots, a corresponding legend 703, an exemplary time-frequency plot 704 illustrating RO to SSB mapping for exemplary non-SBFD slots and exemplary SBFD slots, in accordance with the exemplary embodiment.

Drawing 702 illustrates an exemplary sequence of slots including: uplink (U) slot 710, SBFD slot 712, downlink (D) slot 714, downlink (D) slot 716, downlink D slot 718, uplink (U) slot 720, downlink (D) slot 722, downlink D slot 724, downlink (D) slot 726 and downlink (D) slot 728. Legend 703 indicates that crosshatch shading, as shown in sample box 705, is used to indicate uplink resources within the sequence of slots of drawing 702, and no shading, as shown in sample box 707, is used to indicate downlink resources within the sequence of slots of drawing 702. It may be observed that the majority of resources within a SBFD slot are designated to be downlink resources, while a minority of the resources of the uplink slot are designated to be used as uplink resources.

Time-frequency plot 704 includes a vertical axis 706 representing frequency and a horizontal axis 708 representing time. Non-SBFD slot 710, which is an uplink slot, designated with a U, includes four RACH Occasions (ROs), which are: RO1 722, RO2 724, RO3 726, and RO4 728. SSB 1 is mapped to RO1 722 in non-SBFD slot 710. SSB 2 is mapped to RO2 724 in non-SBFD slot 710. SSB 3 is mapped to RO3 726 in non-SBFD slot 710. SSB 4 is mapped to RO4 728 in non-SBFD slot 710.

SBFD slot 712, designated with a X, includes two RACH Occasions (ROs), which are: RO1 730 and RO2 732. Four SSBs, which are: SSB 1, SSB 2, SSB 3 and SSB 4, are mapped to RO1 730 in SBFD slot 712. Four SSBs, which are: SSB 5, SSB 6, SSB 7 and SSB 8, are mapped to RO2 732 in SBFD slot 712.

No ROs are mapped to any of slots 714, 716 and 718, which are downlink slots and do no include any uplink resources.

Non-SBFD slot 720, which is an uplink slot, designated with a U, includes four RACH Occasions (ROs), which are: RO5 734, RO6 736, RO7 738, and RO8 740. SSB 5 is mapped to RO5 734 in non-SBFD slot 720. SSB 6 is mapped to RO6 736 in non-SBFD slot 720. SSB 7 is mapped to RO7 738 in non-SBFD slot 720. SSB 8 is mapped to RO8 740 in non-SBFD slot 720.

Exemplary non-SBFD PRACH signal duration 760, which is, e.g., 12 OFDM symbols duration in time for a 14 symbol length slot, is also shown in FIG. 7. Exemplary SBFD PRACH signal duration 762, which is, e.g., 12 OFDM symbols duration in time for a 14 symbol length slot, is also shown in FIG. 6. The association period 764, for SSB to RO mapping for both non-SBFD type symbols/slots and SBFD type symbols/slots is 10 msec.

Table 709 is comparison table comparing non-SBFD symbols/slot to SBFD symbols/slots, with regard to SSB-RO mapping of the example shown in drawing 704. Association periodicity is the same value, which is 10 msec, for both non-SBFD type and SBFD type. The number of SSB per RO is different for non-SBFD type and the SBFD type; for the non-SBFD type there is 1 SSB per RO, while for the SBFD type there are 4 SSBs per RO. The PRACH signal duration is the same value, which is 12 OFDM symbols, in a slot size of 14 OFDM symbols, for both non-SBFD type and SBFD type.

It may also be observed that there are a different number of ROs in non-SBFD slots as compared to SBFD slots; each of the non-SBFD slots (710, 720) includes 4 ROs, while each of the SBFD slots (712) includes 2 ROs. It may also be observed that each RO is the same size, in terms of time-frequency resources, irrespective of whether the RO is within a non-SBFD slot or a SBFD slot.

FIG. 8 is a drawing 800 illustrating different SSB-RO mapping for non-SBFD symbols and SBFD symbols, in accordance with still another exemplary embodiment. Drawing 800 includes a drawing 802 illustrating an exemplary mapping of slots in accordance with an exemplary timing-frequency structure, the slots including uplink slots, downlink slots, an SBFD slots, a corresponding legend 803, an exemplary time-frequency plot 804 illustrating RO to SSB mapping for exemplary non-SBFD slots and exemplary SBFD slots, in accordance with the exemplary embodiment.

Drawing 802 illustrates an exemplary sequence of slots including: uplink (U) slot 810, SBFD slot 812, SBFD slot 814, downlink (D) slot 816, downlink D slot 818, uplink (U) slot 820, downlink (D) slot 822, downlink D slot 824, downlink (D) slot 826 and downlink (D) slot 828. Legend 803 indicates that crosshatch shading, as shown in sample box 805, is used to indicate uplink resources within the sequence of slots of drawing 802, and no shading, as shown in sample box 807, is used to indicate downlink resources within the sequence of slots of drawing 802. It may be observed that the majority of resources within a SBFD slot are designated to be downlink resources, while a minority of the resources of the uplink slot are designated to be used as uplink resources.

Time-frequency plot 804 includes a vertical axis 806 representing frequency and a horizontal axis 808 representing time. Non-SBFD slot 810, which is an uplink slot, designated with a U, includes four RACH Occasions (ROs), which are: RO1 822, RO2 824, RO3 826, and RO4 828. SSB 1 is mapped to RO1 822 in non-SBFD slot 810. SSB 2 is mapped to RO2 824 in non-SBFD slot 810. SSB 3 is mapped to RO3 826 in non-SBFD slot 810. SSB 4 is mapped to RO4 828 in non-SBFD slot 810.

SBFD slot 812, designated with a X, includes two RACH Occasions (ROs), which are: RO1 830 and RO2 832. Two SSBs, which are: SSB 1 and SSB 2, are mapped to RO1 830 in SBFD slot 812. Two SSBs, which are: SSB 3 and SSB 4, are mapped to RO2 832 in SBFD slot 812.

SBFD slot 814, designated with a X, includes two RACH Occasions (ROs), which are: RO3 834 and RO4 836. Two SSBs, which are: SSB 5 and SSB 6, are mapped to RO3 834 in SBFD slot 814. Two SSBs, which are: SSB 7 and SSB 8, are mapped to RO4 836 in SBFD slot 814.

No ROs are mapped to any of slots 816 and 718, which are downlink slots and do no include any uplink resources.

Non-SBFD slot 820, which is an uplink slot, designated with a U, includes four RACH Occasions (ROs), which are: RO5 838, RO6 840, RO7 842, and RO8 844. SSB 5 is mapped to RO5 838 in non-SBFD slot 820. SSB 6 is mapped to RO6 840 in non-SBFD slot 820. SSB 7 is mapped to RO7 842 in non-SBFD slot 720. SSB 8 is mapped to RO8 844 in non-SBFD slot 820.

Exemplary non-SBFD PRACH signal duration 860, which is, e.g., 12 OFDM symbols duration in time for a 14 symbol length slot, is also shown in FIG. 8. Exemplary SBFD PRACH signal duration 862, which is, e.g., 12 OFDM symbols duration in time for a 14 symbol length slot, is also shown in FIG. 8. The association period 864, for SSB to RO mapping for both non-SBFD type symbols/slots and SBFD type symbols/slots is 10 msec.

Table 809 is comparison table comparing non-SBFD symbols/slots to SBFD symbols/slots, with regard to SSB-RO mapping of the example shown in drawing 804. Association periodicity is the same value, which is 10 msec, for both non-SBFD type and SBFD type. The number of SSB per RO is different for non-SBFD type and the SBFD type; for the non-SBFD type there is 1 SSB per RO, while for the SBFD type there are 2 SSBs per RO. The PRACH signal duration is the same value, which is 12 OFDM symbols, in a slot size of 14 OFDM symbols, for both non-SBFD type and SBFD type.

It may also be observed that there are a different number of ROs in non-SBFD slots as compared to SBFD slots; each of the non-SBFD slots (710, 720) includes 4 ROs, while each of the SBFD slots (712) includes 2 ROs. It may also be observed that each RO is the same size, in terms of time-frequency resources, irrespective of whether the RO is within a non-SBFD slot of a SBFD slot.

FIG. 9 is a drawing illustrating different SSB-RO mapping for non-SBFD symbols and SBFD symbols, in accordance with yet another exemplary embodiment. Drawing 900 includes a drawing 902 illustrating an exemplary mapping of slots in accordance with an exemplary timing-frequency structure, the slots including uplink slots, downlink slots, an SBFD slots, a corresponding legend 903, an exemplary time-frequency plot 904 illustrating RO to SSB mapping for exemplary non-SBFD slots and exemplary SBFD slots, in accordance with the exemplary embodiment.

Drawing 902 illustrates an exemplary sequence of slots including: uplink (U) slot 910, SBFD slot 912, SBFD slot 914, downlink (D) slot 916, downlink D slot 918, uplink (U) slot 920, downlink (D) slot 922, downlink (D) slot 924, downlink (D) slot 926 and downlink (D) slot 928. Legend 903 indicates that crosshatch shading, as shown in sample box 905, is used to indicate uplink resources within the sequence of slots of drawing 902, and no shading, as shown in sample box 907, is used to indicate downlink resources within the sequence of slots of drawing 902. It may be observed that the majority of resources within a SBFD slot are designated to be downlink resources, while a minority of the resources of the uplink slot are designated to be used as uplink resources.

Time-frequency plot 904 includes a vertical axis 906 representing frequency and a horizontal axis 908 representing time. Non-SBFD slot 910, which is an uplink slot, designated with a U, includes four RACH Occasions (ROs), which are: RO1 922, RO2 924, RO3 926, and RO4 928. SSB 1 is mapped to RO1 922 in non-SBFD slot 910. SSB 2 is mapped to RO2 924 in non-SBFD slot 910. SSB 3 is mapped to RO3 926 in non-SBFD slot 910. SSB 4 is mapped to RO4 928 in non-SBFD slot 910.

SBFD slot 912, designated with a X, includes four RACH Occasions (ROs), which are: RO1 930, RO2 932, RO3 934 and RO4 936. SSB 1 is mapped to RO1 930 in SBFD slot 912. SSB 2 is mapped to RO2 932 in SBFD slot 912. SSB 3 is mapped to RO3 934 in SBFD slot 912. SSB 4 is mapped to RO4 936 in SBFD slot 912.

SBFD slot 914, designated with a X, includes four RACH Occasions (ROs), which are: RO5 938, RO6 940, RO7 942 and RO8 942. SSB 5 is mapped to RO5 938 in SBFD slot 914. SSB 6 is mapped to RO6 940 in SBFD slot 914. SSB 7 is mapped to RO7 942 in SBFD slot 914. SSB 8 is mapped to RO8 944 in SBFD slot 914.

No ROs are mapped to any of slots 916 and 818, which are downlink slots and do no include any uplink resources.

Non-SBFD slot 920, which is an uplink slot, designated with a U, includes four RACH Occasions (ROs), which are: RO5 946, RO6 948, RO7 950, and RO8 952. SSB 5 is mapped to RO5 946 in non-SBFD slot 920. SSB 6 is mapped to RO6 948 in non-SBFD slot 920. SSB 7 is mapped to RO7 950 in non-SBFD slot 920. SSB 8 is mapped to RO8 952 in non-SBFD slot 920.

Exemplary non-SBFD PRACH signal duration 960, which is, e.g., 12 OFDM symbols duration in time for a 14 symbol length slot, is also shown in FIG. 9. Exemplary SBFD PRACH signal duration 962, which is, e.g., 6 OFDM symbols duration in time for a 14 symbol length slot, is also shown in FIG. 9. The association period 964, for SSB to RO mapping for both non-SBFD type symbols/slots and SBFD type symbols/slots is 10 msec.

Table 909 is comparison table comparing non-SBFD symbols/slots to SBFD symbols/slots, with regard to SSB-RO mapping of the example shown in drawing 904. Association periodicity is the same value, which is 10 msec, for both non-SBFD type and SBFD type. The number of SSB per RO is 1, which is the same for non-SBFD type and the SBFD type. The PRACH signal duration is different for non-SBFD and SBFD; the PRACH signal duration for the non-SBFD type slot is 12 OFDM symbols, in a slot size of 14 OFDM symbols, while the PRACH signal duration for the SBFD type slot is 6 OFDM symbols, in a slot size of 14 OFDM symbols. The number of time-domain ROs in a slot is different for the non-SBFD slot and the SBFD slot. There is only 1 time domain for ROs in a non-SBFD slot, while there are two time domain for ROs in a SBFD slot.

It may also be observed that there are the same number of ROs in non-SBFD slots and SBFD slots, with each slot have 4 ROs. It may also be observed that each ROs are different sizes, in terms of time-frequency resources, when comparing a non-SBFD slot to a SBFD slot. A RO in a non-SBFD slot occupies twice the time-frequency resources that a RO in a SBFD slot occupies.

FIG. 10 is a drawing illustrating different SSB-RO mapping for non-SBFD symbols and SBFD symbols, in accordance with another exemplary embodiment. Drawing 1000 includes a drawing 1002 illustrating an exemplary mapping of slots in accordance with an exemplary timing-frequency structure, the slots including uplink slots, downlink slots, an SBFD slots, a corresponding legend 1003, an exemplary time-frequency plot 1004 illustrating RO to SSB mapping for exemplary non-SBFD slots and exemplary SBFD slots, in accordance with the exemplary embodiment.

Drawing 1002 illustrates an exemplary sequence of slots including: uplink (U) slot 1010, SBFD slot 1012, SBFD slot 1014, downlink (D) slot 1016, downlink D slot 1018, uplink (U) slot 1020, downlink (D) slot 1022, downlink (D) slot 1024, downlink (D) slot 1026 and downlink (D) slot 1028. Legend 1003 indicates that crosshatch shading, as shown in sample box 1005, is used to indicate uplink resources within the sequence of slots of drawing 1002, and no shading, as shown in sample box 1007, is used to indicate downlink resources within the sequence of slots of drawing 1002. It may be observed that the majority of resources within a SBFD slot are designated to be downlink resources, while a minority of the resources of the uplink slot are designated to be used as uplink resources.

Time-frequency plot 1004 includes a vertical axis 1006 representing frequency and a horizontal axis 1008 representing time. Non-SBFD slot 1010, which is an uplink slot, designated with a U, includes two RACH Occasions (ROs), which are: RO1 1024 and RO2 1026. SSB 1 and SSB 2 are mapped to RO1 1024 in non-SBFD slot 1010. SSB 3 and SSB 4 are mapped to RO2 1026 in non-SBFD slot 1010.

SBFD slot 1012, designated with a X, includes two RACH Occasions (ROs), which are: RO1 1032 and RO2 1034. SSB 1 is mapped to RO1 1032 in SBFD slot 1012. SSB 2 is mapped to RO2 1034 in SBFD slot 1012.

SBFD slot 1014, designated with a X, includes two RACH Occasions (ROs), which are: RO3 1036 and RO4 1038. SSB 3 is mapped to RO3 1036 in SBFD slot 1014. SSB 4 is mapped to RO4 1038 in SBFD slot 1014.

Non-SBFD slot 1020, which is an uplink slot, designated with a U, includes two RACH Occasions (ROs), which are: RO3 1040 and RO4 1042. SSB 5 and SSB 6 are mapped to RO3 1040 in non-SBFD slot 1040. SSB 7 and SSB 8 are mapped to RO4 1042 in non-SBFD slot 1020.

Non-SBFD slot 1010′, which is an uplink slot, designated with a U, includes two RACH Occasions (ROs), which are: RO1 1044 and RO2 1056. SSB 1 and SSB 2 are mapped to RO1 1044 in non-SBFD slot 1010′. SSB 3 and SSB 4 are mapped to RO2 1046 in non-SBFD slot 1010′.

SBFD slot 1012′, designated with a X, includes two RACH Occasions (ROs), which are: RO5 1048 and RO6 1050. SSB 1 is mapped to RO5 1048 in SBFD slot 1012′. SSB 2 is mapped to RO6 1050 in SBFD slot 1012′.

SBFD slot 1014′, designated with a X, includes two RACH Occasions (ROs), which are: RO7 1052 and RO8 1054. SSB 7 is mapped to RO7 1052 in SBFD slot 1014′. SSB 8 is mapped to RO8 1054 in SBFD slot 1014′.

Non-SBFD slot 1020′, which is an uplink slot, designated with a U, includes two RACH Occasions (ROs), which are: RO3 1056 and RO4 1058. SSB 5 and SSB 6 are mapped to RO3 1056 in non-SBFD slot 1020′. SSB 7 and SSB 8 are mapped to RO4 1058 in non-SBFD slot 1010′.

Exemplary non-SBFD PRACH signal duration 1060, which is, e.g., 12 OFDM symbols duration in time for a 14 symbol length slot, is also shown in FIG. 10. Exemplary SBFD PRACH signal duration 1062, which is, e.g., 12 OFDM symbols duration in time for a 14 symbol length slot, is also shown in FIG. 9. The association period 1064, for SSB to RO mapping for both non-SBFD type symbols/slots is 10 msec. The association period 1066, for SSB to RO mapping for both SBFD type symbols/slots is 20 msec.

Table 1009 is a comparison table comparing non-SBFD symbols/slots to SBFD symbols/slots, with regard to SSB-RO mapping of the example shown in drawing 1004. Association periodicity is different for non-SBFD type symbols/slots and SBFD type symbols/slots. For non-SBFD type symbols/slots the association time period is 10 msec, while for SBFD type symbols/slots the association time period is 20 msec. The number of SSBs per slot is different for non-SBFD slots compared to SBFD slots. For non-SBFD slots there are 2 SSB per RO, while for SBFD slots there are only 1 SSB per RO. The PRACH signal duration is the same value, which is 12 OFDM symbols, in a slot size of 14 OFDM symbols, for both non-SBFD type and SBFD type.

It may also be observed that there are the same number of ROs in non-SBFD slots and SBFD slots, with each slot having 2 ROs. It may also be observed that ROs are the same size, in terms of time-frequency resources, for non-SBFD slots and SBFD slots.

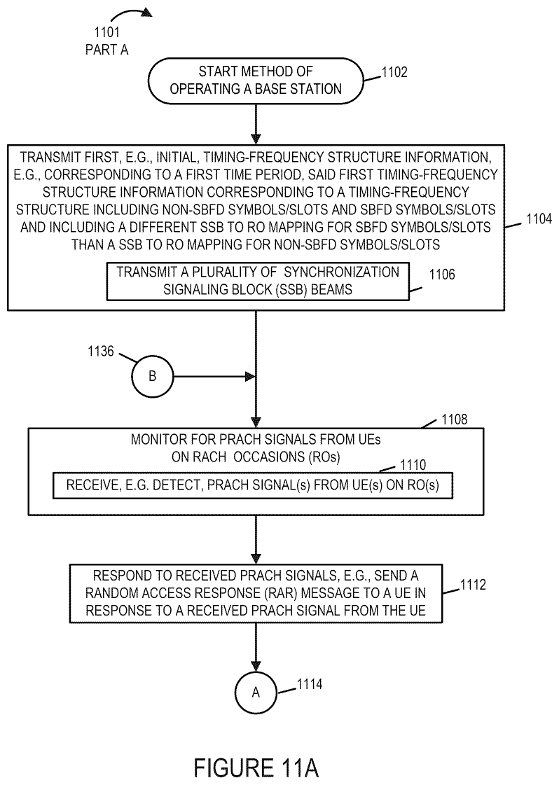

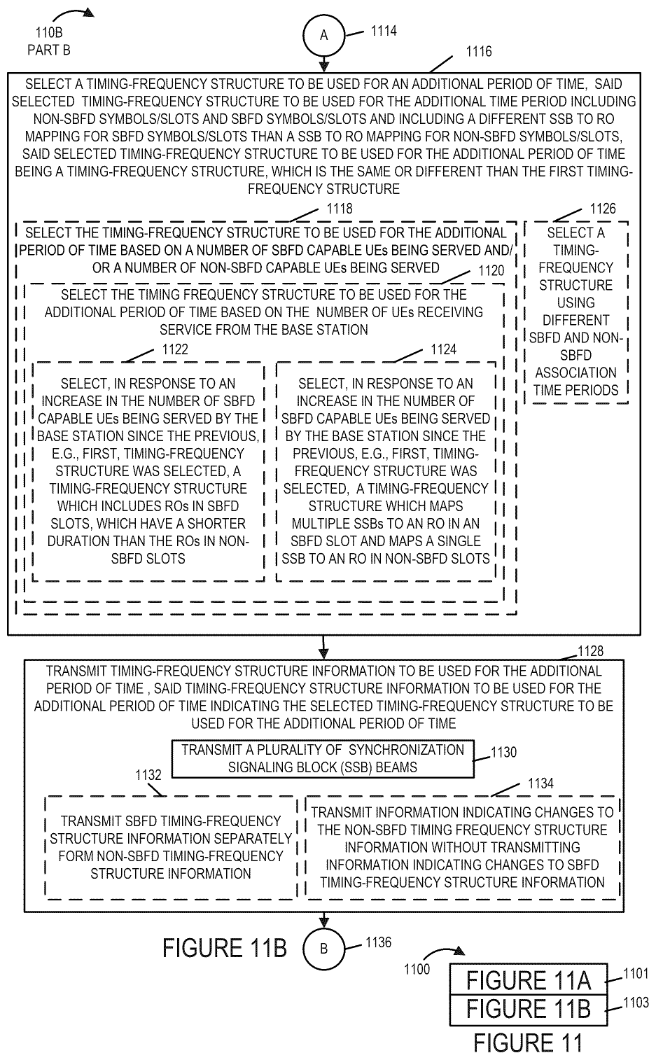

FIG. 11, comprising the combination of FIG. 11A and FIG. 11B, is a flowchart 1100, comprising the combination of Part A 1101 and Part B 1103, of an exemplary method of operating a base station, e.g., a gNB, in accordance with an exemplary embodiment. The exemplary base station implementing the method of flowchart 1100 is, e.g., any of base station 1 102 or base station M 104 of system 100 of FIG. 1, or base station 200 of FIG. 2.

Operation of the exemplary method starts in step 1102, in which the base station is powered on and initialized. Operation proceeds from start step 1102 to step 1104, in which the base station transmits first, e.g., initial, timing-frequency structure information, e.g., corresponding to be used a first time period, said initial timing-frequency structure information corresponding to a timing-frequency structure including non-SBFD symbols/slots and SBFD symbols/slots and including a different SSB to RO mapping for SBFD symbols/slots than a SSB to RRO mapping for non-SBFD symbols/slots. In some embodiments, the first timing-frequency structure for the first period of time includes more non-SBFD slots than SBFD slots and more downlink slots than SBFD slots. Step 1104 includes step 1106, in which the base station transmits a plurality of synchronization signaling block (SSB) beams, each SSB beam communicating System Information Block (SIB) information including SIB1 information, corresponding to the SSB beam. Operation proceeds from step 1106 to step 1108.

In step 1108 the base station monitors for PRACH signals from UEs being communicated on RACH Occasions (ROs) included in the non-SBFD symbols and slots and ROs included in SBFD symbols and slots during the first time period. Step 1108 includes step 1110, in which the base station receives, e.g., detects, PRACH signals being communicated on ROs. Operation proceeds from step 1110 to step 1112 In step 1112, the base station responds to received PRACH signals. For example, the response of step 1110 includes operating the base station to sends a RAR message, identifying PUSCH resources to be used, in response to a received PRACH signal from a UE. Operation proceeds from step 1112 via connecting node A 1114 to step 1116 of FIG. 11B.

In step 1116 the base station selects a timing-frequency structure to be used for an additional time period based, said selected timing-frequency structure to be used for the additional period of time including non-SBFD symbols/slots and SBFD symbols/slots and including a different SSB to RO mapping for SBFD symbols/slots than a SSB to RO mapping for non-SBFD symbols/slots, said selected timing-frequency structure to be used for the additional period of time being the same or different than the first timing-frequency structure.

Step 1116 includes, in some embodiments, one or both of optional steps 1118 and 1126. In step 1118 the base station selects the timing-frequency structure to be used for the additional period of time based on a number of SBFD capable UEs being served by the base station and/or a number of non-SBFD capable UEs being served by the base station. In some embodiments, step 1118 includes step 1120, in which the base station selects the timing-frequency structure to be used for the additional period of time based on the number of UEs receiving service from the base station. In some embodiments, step 1120 includes one of steps 1122 and 1124. In step 1122 the base station selects, in response to an increase in the number of SBFD capable UEs being served by the base station since the previous, e.g., first, timing-frequency structure was selected, a timing-frequency structure, which includes ROs in SBFD slots, which have a shorter duration than ROs in non-SBFD slots, said selected timing-frequency structure to be used for the additional period of time. In step 1124 the base station selects, in response to an increase in the number of SBFD capable UEs being served by the base station since the previous, e.g., first, timing-frequency structure was selected, a timing-frequency structure, which maps multiple SSBs to an RO in SBFD slot and maps a single SSB to an RO in non-SBFD slots, said selected timing-frequency structure to be used for the additional period of time. Returning to step 1126, in step 1126, the base station selects a timing-frequency structure using different SBFD and non-SBFD association time periods, with regard to ROs and SSB to RO mapping, said selected timing-frequency structure to be used for the additional period of time. In some such embodiments, the SBFD association time period is longer than the non-SBFD association time period, e.g., 20 msec vs 10 msec. Operation proceeds from step 1116 to step 1128.

In step 1128 the base station transmits timing-frequency structure information to be used for the additional period of time, said timing-frequency structure information to be used for the additional period of time indicating the selected timing-frequency structure to be used for the additional period of time. Step 1128 includes step 1130, in which the base station transmits a plurality of SSB beams, each SSB beam communicating System Information Block (SIB) information including SIB1 information, corresponding to the SSB beam. Step 1128 may, and sometimes does, include step 1132 and/or step 1134. In step 1132 the base station transmits SBFD time-frequency structure information separately from non-SBFD structure information. In step 1134 the base station transmits information indicating changes to the non-SBFD timing-frequency structure information without transmitting information indicating changes to SBFD timing-frequency structure information.

In various embodiments, the non-SBFD timing-frequency structure information is updated at a faster rate than the SBFD timing frequency structure information.

Operation proceeds from step 1128, via connecting node B 1136, to step 1108, in which the base station monitors for PRACH signals from UEs on ROs during the additional period of time.

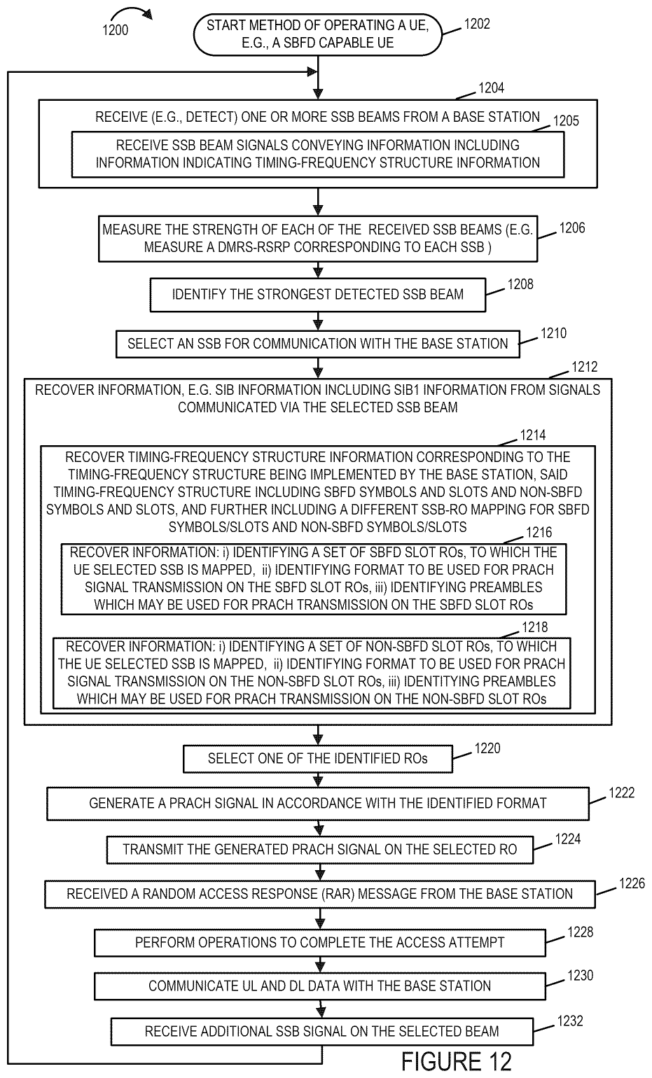

FIG. 12 is a flowchart 1200 of an exemplary method of operating a user equipment, e.g., a SBFD capable UE, in accordance with an exemplary embodiment. The exemplary UE implementing the method of flowchart 1200 is, e.g., any of UE1A 106, UENA 108, UE1C 114, or UENC 116 of system 100 of FIG. 1 or UE 300 of FIG. 3.

The exemplary method starts in step 102, in which the UE is powered on and initialized. Operation proceeds from start step 1202 to step 1204, in which the UE receives, e.g., detects, one or more SSB beams from a base station, e.g. base station 102 of system 100 of FIG. 1. Step 1204 includes step 1205 in which the base station receives SSB beam signals conveying information including information indicating timing-frequency structure information. Operation proceeds from step 1204 to step 1206, in which the UE measures the strength of each of the received SSB beams, e.g., the UE measures a DMRS-RSRP corresponding to each SSB. Operation proceeds from step 1206 to step 1208, in which the UE identifies the strongest detected SSB beam. Operation proceeds from step 1208 to step 1210, in which the UE selects a SSB for communication with the base station, e.g., the UE selects the SSB index corresponding to the strongest received SSB beam from the base station. Operation proceeds from step 1210 to step 1212.

In step 1212 the UE recovers information, e.g., SIB information including SIB1 information from received signals communicated via the selected SSB beam. Step 1212 includes step 1214, in which the UE recovers timing-frequency structure information corresponding to the timing-frequency being implemented by the base station, said timing-frequency structure including SBFD symbols and slots and non-SBFD symbols and slots, and further including a different SSB-RO mapping for SBFD symbols/slots and non-SBFD symbols/slots. Step 1214 includes step 1216 and step 1218. In step 1216 the UE recovers information: i) identifying a set of SBFD slot ROs, to which the UE selected SSB is mapped, ii) identifying format to be used for PRACH signal transmission on the SBFD slot ROs, and iii) identifying preambles which may be used for PRACH signal transmission on the SBFD slot ROs. In step 1218 the UE recovers information: i) identifying a set of non-SBFD slot ROs, to which the UE selected SSB is mapped, ii) identifying format to be used for PRACH signal transmission on the non-SBFD slot ROs, and iii) identifying preambles which may be used for PRACH signal transmission on the non-SBFD slot ROs. Operation proceeds from step 1212 to step 1220.

In step 1220 the UE selects one of the identified ROs. Operation proceeds from step 1220 to step 1222, in which the UE generates a PRACH signal in accordance with the identified format and allowable preambles corresponding to the selected RO. Operation proceeds from step 1222 to steps 1224, in which the UE transmits the generated PRACH signal including a preamble on the selected RO. Operation proceeds from step 1224 to step 1226, in which the UE receives a random access response (RAR) message from the base station, e.g., identifying PUSCH resources to be used by the UE. Operation proceeds from step 1126 to step 1228, in which the UE performs operations to compete the random access attempt, e.g., generating and sending a PUSCH signal and receiving a response message from the base station. Operation proceeds from step 1228 to step 1230, in which the UE communicates UL and DL control and traffic data with the base station. Operation proceeds from step 1230 to step 1204. The base station performs another iteration of step 1204, in which the UE receives one or more SSB beams from the base station for an additional time period. Step 1204 includes step 1205, in which the base station receives SSB beam signals conveying information including information indicating timing-frequency structure information for the additional time period. In some embodiments, the base station may decide to remain on the previously selected SSB, and operation proceeds from step 1204 to step 1212, while in other embodiments, another iteration of steps 1206, 1208 and 1210 is performed. Operation proceeds from step 1204 or from step 1210 to step 1212, in which the UE recovers information corresponding to a timing-frequency structure being implemented by the base station. The timing-frequency structure being implemented by the base station may be, and sometimes is a different (new) timing-frequency structure than was the timing-frequency structure which was recovered in the first iteration of step 1212, said new timing-frequency structure, e.g., including, e.g., a different slot structure with regard to SBFD slots, non-SBFD slots and DL slots, and/or a different SSB-RO mapping for non-SBFD slots and/or a different SSB-RO mapping for SBFD slots.

In each of the following lists of numbered embodiments, a reference to an earlier numbered embodiment refers to a numbered embodiment within the same list.

### First Numbered List of Exemplary Method Embodiments

Method Embodiment 1. A method of operating a base station, the method comprising: transmitting (1104) first timing-frequency structure information to be used for a first period of time (e.g. said first period of time including an association period corresponding to one or both non-sub-band full duplex (non-SBFD) slots and sub-band full duplex (SBFD) slots, with the first period of time being at least as long as the longer one of a non-SBFD and SBFD association periods if they are different so that the first period of time covers at least one non-SBFD association period and at least one SBFD association period), said first timing-frequency structure information indicating (e.g., timing and/or frequency location of ROs) RACH Occasions (ROs) in non-SBFD symbols (and slots) and SBFD symbols (and slots) (e.g., Random Access Channel Occasions (ROs) during which a UE can use a physical random access channel (PRACH) to send an access signal, e.g., a PRACH signal including a preamble) within a timing-frequency structure used by the base station; and monitoring (1108) for PRACH signals from UEs being communicated on ROs included in the non-SBFD and SBFD symbols.

Method Embodiment 1A. The method of Method Embodiment 1, wherein the first period of time includes at least one non-SBFD association period and at least one SBFD association period; and wherein the first timing-frequency structure information includes at least one set of SBFD timing-frequency structure information and at least one set of non-SBFD timing-frequency information.

Method Embodiment 1AA. The method of Method Embodiment 1, wherein the first timing-frequency structure information includes a different SSB-RO mapping for non-SBFD symbols and slots than an SSB-RO mapping for SBFD symbols and slots.

Method Embodiment 1AA1. The method of Method Embodiment 1AA, wherein said first timing-frequency structure information indicates that at least one SSB is mapped to a RO, using a first set of frequencies (e.g., a first set of 12 RBs, i.e. 144 subcarriers), in a non-SBFD slot and is mapped to a RO using a second set of frequencies (e.g., a second set of RBs, i.e. 144 subcarriers) in a SBFD slot, said first set of frequencies being different than said second set of frequencies.

Method Embodiment 1B. The method of Method Embodiment 1A, wherein SBFD symbols are included in SBFD slots; wherein non-SBFD symbols are included in non-SBFD slots; wherein the non-SBFD association period relates to a period of time in which information provided for ROs in non-SBFD symbols and slots is valid; and wherein the SBFD association period relates to a period of time in which information provided for ROs in SBFD symbols and slots is valid.

Method Embodiment 1BAA. The method of Method Embodiment 1B, wherein the non-SBFD association period and SBFD association period are the same during said first period of time.

Method Embodiment 1C. The method of Method Embodiment 1, further comprising: selecting (1116) a timing-frequency structure to be used for an additional period of time, said timing-frequency structure to be used for the additional period of time being a timing-frequency structure which is the same or different than the first timing-frequency structure; and transmitting (1128) information indicating the selected timing-frequency structure to be used during the additional period of time.

Method Embodiment 1CA. The method of Method Embodiment 1C, wherein the non-SBFD association period duration and SBFD association period duration are different during said additional period of time.

Method Embodiment 1CB. The method of Method Embodiment 1C, wherein the non-SBFD association period is 10 ms and wherein the SBFD association period is 20 ms.

Method Embodiment 1D. The method of Method Embodiment 1C, wherein selecting (1116) the timing-frequency structure to be used for the additional period of time is based (1120) on the number of UEs receiving service from the base station

Method Embodiment 1DA. The method of Method Embodiment 1D, wherein the first timing-frequency structure includes ROs in non-SBFD slots and ROs in SBFD slots that have the same duration (FIG. 8) (e.g. a PRACH signal duration corresponding to, e.g., the duration of 12 OFDM symbols).

Method Embodiment 1E. The method of Method Embodiment 1DA, wherein selecting (1116) the timing-frequency structure to be used for the additional period of time includes selecting (1122), in response to an increase in the number of SBFD capable UEs being served by the base station since the first timing-frequency structure was selected, a timing-frequency structure which includes ROs in SBFD slots (FIG. 9) which have a shorter duration than the duration of ROs in non-SBFD slots (e.g., ROs in SBFD slots correspond to fewer OFDM symbol time periods than ROs in non-SBFD slots).

Method Embodiment 1EA. The method of Method Embodiment 1DA, wherein selecting (1116) the timing-frequency structure to be used for the additional period of time includes selecting (1124), in response to an increase in the number of SBFD capable UEs being served by the base station since the first timing-frequency structure was selected, a timing-frequency structure which maps multiple SSBs to an RO in an SBFD slot and maps a single SSB to an RO in non-SBFD slots.

Method Embodiment 1EA2. The method of Method Embodiment 1DA, wherein selecting (1116) the timing-frequency structure to be used for the additional period of time includes selecting (1124), a timing-frequency structure to be used for the additional period of time, a timing-frequency structure which maps a first number of SSBs to a RO for SBFD slots and a second number of SSBs to a RO for non-SBFD slots, said first number being different than said second number (e.g., 1 SSB is mapped to a non-SBFD slot and 2 or 4 SSB are mapped to a RO for a SBFD slot).

Method Embodiment 1EA3. The method of Method Embodiment 1EA2, wherein the base station partitions (e.g., evenly divides) an available set of preambles between the SSBs, which are mapped to the same RO.

Method Embodiment 1D. The method of Method Embodiment 1C, wherein during the first period of time the SBFD and non-SBFD association periods are the same (FIG. 8); wherein selecting (1116) the timing-frequency structure to be used for an additional period of time includes selecting (1126) a timing-frequency structure using different SBFD and non-SBFD association periods; and wherein the SBFD association period is longer than the non-SBFD association period.

Method Embodiment 1E. The method of Method Embodiment 1C, wherein transmitting (1128) information indicating the selected timing-frequency structure to be used during the additional period of time includes transmitting SBFD timing-frequency structure information separately from non-SBFD timing-frequency structure information.

Method Embodiment 1EA. The method of Method Embodiment 1C, wherein transmitting (1128) information indicating the selected timing-frequency structure to be used during the additional period of time includes transmitting (1134) information indicating changes to non-SBFD timing-frequency structure information without transmitting information indicating changes to SBFD timing-frequency structure information.

Method Embodiment 1F. The method of Method Embodiment 1C wherein the non-SBFD timing-frequency is updated at a faster rate than the SBFD timing frequency structure information.

Method Embodiment 1G. The method of Method Embodiment 1, wherein a first timing-frequency structure for the first period of time includes more non-SBFD UL slots than SBFD slots and more downlink slots than SBFD slots, said first timing-frequency structure corresponding to the first timing-frequency structure information. (See FIG. 7)

Method Embodiment 1G1. The method of Method Embodiment 1, wherein a first timing-frequency structure for the first period of time includes more SBFD slots than non-SBFD UL slots, said first timing-frequency structure corresponding to the first timing-frequency structure information. (e.g., See FIG. 6)

Method Embodiment 1G2. The method of Method Embodiment 1, wherein the timing-frequency structure for the first period of time includes the same number of SBFD slots as the number of non-SBFD UL slots (e.g., See FIG. 8, 9 or 10), said first timing-frequency structure corresponding to the first timing-frequency structure information.

Method Embodiment 2. The method of Method Embodiment 1, wherein in the first timing-frequency structure information, the ROs in the non-SBFD slots and the ROs in the SBFD slots have an association period which is the same, a number of Synchronization Signal Blocks (SSBs) per RO (e.g., number of SSB indices mapped to an RO) is the same for both non-SBFD slots and SBFD slots, and an RO duration is the same for both non-SBFD and SBFD slots. (e.g., the non-SBFD and SBFD slots have the same association period, same number of SSBs per RO and same PRACH duration which is reflected in the ROs having the same duration).

Method Embodiment 2A. The method of Method Embodiment 2 wherein, in the first timing-frequency structure information, the SSB to RO mapping is different for SBFD slots and non-SBFD slots.

Method Embodiment 2B. The method of Method Embodiment 2A, wherein, in the first timing-frequency structure information, a first SSB (e.g., SSB1) maps to a first RO (e.g., RO1 624) in a non-SBFD slot (e.g., slot 624) and a second RO (e.g., RO1 632) in a SBFD slot (e.g., slot 612), said first RO corresponding to a first set of frequencies, said second RO corresponding to a second set of frequencies, said first set of frequencies being different than said first set of frequencies.

Method Embodiment 3. The method of Method Embodiment 1, wherein in the first timing-frequency structure information, the ROs in the non-SBFD slots and the ROs in the SBFD slots have an association period which is the same for both non-SBFD slots and SBFD slots, an RO duration which is the same (e.g., the same PRACH format is used for ROs in SBFD slots and non-SBFD slots), but non-SBFD slots have a different number of SSBs per RO than SBFD slots.

Method Embodiment 4. The method of Method Embodiment 1, wherein in the first timing-frequency structure information, the ROs in non-SBFD slots and ROs in SBFD slots have an association period which is the same, a number of SSBs per RO which is the same for both non-SBFD slots and SBFD slots, but different RO durations are used for non-SBFD slots and SBFD slots (e.g., non-SBFD slots and SBFD slots use different PRACH durations and/or formats).

Method Embodiment 5. The method of Method Embodiment 1, wherein in the first timing-frequency structure information, the non-SBFD slots and SBFD slots have a number of SSBs per RO which is the same for both non-SBFD slots and SBFD slots, the non-SBFD slots and SBFD slots have a RO duration which is the same for both non-SBFD slots and SBFD slots (e.g., both non-SBFD and SBFD slots have the same PRACH duration), but the non-SBFD slots and SBFD slots have different association periods.

Method Embodiment 5A. The method of Method Embodiment 5, wherein the non-SBFD slots have an association period of 10 ms while the SBFD slots have an association period of 20 ms.

Method Embodiment 6. The method of Method Embodiment 1, wherein in the first timing-frequency structure information, the non-SBFD slots and SBFD slots have a different number of SSBs per RO, said non-SBFD slots having more SSBs mapped to an RO than the SBFD slots (e.g., 2 SSBs are mapped to each RO in a non-SBFD slot and 1 SSB is mapped to an RO in a SBFD slot), and SBFD slots have a RO duration which is the same for both non-SBFD slots and SBFD slots (e.g., both non-SBFD and SBFD slots have the same PRACH duration), but the non-SBFD slots and SBFD slots have different association periods. (See, e.g., FIG. 10.)

Method Embodiment 6A. The method of Method Embodiment 6, wherein the non-SBFD slots have an association period of 10 ms while the SBFD slots have an association period of 20 ms.

### First Numbered List of Exemplary Apparatus Embodiments

Apparatus Embodiment 1. A base station (102 or 104 or 200) comprising: memory (210) storing timing-frequency structure information (254); a transmitter (wireless transmitter 220); a receiver (wireless receiver 218); and a processor (202) configured to control the base station to: transmit (1104) first timing-frequency structure information to be used for a first period of time (e.g. said first period of time including an association period corresponding to one or both non-sub-band full duplex (non-SBFD) slots and sub-band full duplex (SBFD) slots, with the first period of time being at least as long as the longer one of a non-SBFD and SBFD association periods if they are different so that the first period of time covers at least one non-SBFD association period and at least one SBFD association period), said first timing-frequency structure information indicating (e.g., timing and/or frequency location of ROs) RACH Occasions (ROs) in non-SBFD symbols (and slots) and SBFD symbols (and slots) (e.g., Random Access Channel Occasions (ROs) during which a UE can use a physical random access channel (PRACH) to send an access signal, e.g., a PRACH signal including a preamble) within a timing-frequency structure used by the base station; and monitor (1108) for PRACH signals from UEs being communicated on ROs included in the non-SBFD and SBFD symbols.

Apparatus Embodiment 1A. The base station of Apparatus Embodiment 1, wherein the first period of time includes at least one non-SBFD association period and at least one SBFD association period; and wherein the first timing-frequency structure information includes at least one set of SBFD timing-frequency structure information and at least one set of non-SBFD timing-frequency information.

Apparatus Embodiment 1AA. The base station of Apparatus Embodiment 1, wherein the first timing-frequency structure information includes a different SSB-RO mapping for non-SBFD symbols and slots than an SSB-RO mapping for SBFD symbols and slots.

Apparatus Embodiment 1AA1. The base station of Apparatus Embodiment 1AA, wherein said first timing-frequency structure information indicates that at least one SSB is mapped to a RO, using a first set of frequencies (e.g., a first set of 12 RBs, i.e. 144 subcarriers), in a non-SBFD slot and is mapped to a RO using a second set of frequencies (e.g., a second set of RBs, i.e. 144 subcarriers) in a SBFD slot, said first set of frequencies being different than said second set of frequencies.

Apparatus Embodiment 1B. The base station of Apparatus Embodiment 1A, wherein SBFD symbols are included in SBFD slots; wherein non-SBFD symbols are included in non-SBFD slots; wherein the non-SBFD association period relates to a period of time in which information provided for ROs in non-SBFD symbols and slots is valid; and wherein the SBFD association period relates to a period of time in which information provided for ROs in SBFD symbols and slots is valid.

Apparatus Embodiment 1BAA. The base station of Apparatus Embodiment 1B, wherein the non-SBFD association period and SBFD association period are the same during said first period of time.

Apparatus Embodiment 1C. The base station of Apparatus Embodiment 1, wherein the processor is further configured to control the base station to: select (1116) a timing-frequency structure to be used for an additional period of time, said timing-frequency structure to be used for the additional period of time being a timing-frequency structure which is the same or different than the first timing-frequency structure; and transmit (1128) information indicating the selected timing-frequency structure to be used during the additional period of time.

Apparatus Embodiment 1CA. The base station of Apparatus Embodiment 1C, wherein the non-SBFD association period duration and SBFD association period duration are different during said additional period of time.

Apparatus Embodiment 1CB. The base station of Apparatus Embodiment 1C, wherein the non-SBFD association period is 10 ms and wherein the SBFD association period is 20 ms.

Apparatus Embodiment 1D. The base station of Apparatus Embodiment 1C, wherein selecting (1116) the timing-frequency structure to be used for the additional period of time is based (1120) on the number of UEs receiving service from the base station Apparatus Embodiment 1DA. The base station of Apparatus Embodiment 1D, wherein the first timing-frequency structure includes ROs in non-SBFD slots and ROs in SBFD slots have the same duration (FIG. 8) (e.g. a PRACH signal duration corresponding to, e.g., the duration of 12 OFDM symbols).

Apparatus Embodiment 1E. The base station of Apparatus Embodiment 1DA, wherein the processor is configured, as part of being configured to control the base station to select (1116) the timing-frequency structure to be used for the additional period of time, to control the base station to: select (1122), in response to an increase in the number of SBFD capable UEs being served by the base station since the first timing-frequency structure was selected, a timing-frequency structure which includes ROs in SBFD slots (FIG. 9) which have a shorter duration than the duration of ROs in non-SBFD slots (e.g., ROs in SBFD slots correspond to fewer OFDM symbol time periods than ROs in non-SBFD slots).

Apparatus Embodiment 1EA. The base station of Apparatus Embodiment 1DA, wherein the processor is configured, as part of being configured to control the base station to select (1116) the timing-frequency structure to be used for the additional period of time, to control the base station to: select (1124), in response to an increase in the number of SBFD capable UEs being served by the base station since the first timing-frequency structure was selected, a timing-frequency structure which maps multiple SSBs to an RO in an SBFD slot and maps a single SSB to an RO in non-SBFD slots.

Apparatus Embodiment 1EA2. The base station of Apparatus Embodiment 1DA, the processor is configured, as part of being configured to control the base station to select (1116) the timing-frequency structure to be used for the additional period of time, to control the base station to: select (1124), a timing-frequency structure to be used for the additional period of time, a timing-frequency structure which maps a first number of SSBs to a RO for SBFD slots and a second number of SSBs to a RO for non-SBFD slots, said first number being different than said second number (e.g., 1 SSB is mapped to a non-SBFD slot and 2 or 4 SSB are mapped to a RO for a SBFD slot).

Apparatus Embodiment 1EA3. The base station of Apparatus Embodiment 1EA2, wherein the processor is configured to control the base station to: partition (e.g., evenly divides) an available set of preambles between the SSBs, which are mapped to the same RO.

Apparatus Embodiment 1D. The base station of Apparatus Embodiment 1C, wherein during the first period of time the SBFD and non-SBFD association periods are the same (FIG. 8); wherein selecting (1116) the timing-frequency structure to be used for an additional period of time includes selecting (1126) a timing-frequency structure using different SBFD and non-SBFD association periods; and wherein the SBFD association period is longer than the non-SBFD association period.

Apparatus Embodiment 1E. The base station of Apparatus Embodiment 1C, wherein transmitting (1128) information indicating the selected timing-frequency structure to be used during the additional period of time includes transmitting SBFD timing-frequency structure information separately from non-SBFD timing-frequency structure information.

Apparatus Embodiment 1EA. The base station of claim 1C, wherein transmitting (1128) information indicating the selected timing-frequency structure to be used during the additional period of time includes transmitting (1134) information indicating changes to non-SBFD timing-frequency structure information without transmitting information indicating changes to SBFD timing-frequency structure information.

Apparatus Embodiment 1F. The base station of Apparatus Embodiment 1C wherein the non-SBFD timing-frequency is updated at a faster rate than the SBFD timing frequency structure information.

Apparatus Embodiment 1G. The base station of Apparatus Embodiment 1, wherein a first timing-frequency structure for the first period of time includes more non-SBFD UL slots than SBFD slots and more downlink slots than SBFD slots, said first timing-frequency structure corresponding to the first timing-frequency structure information. (See FIG. 7)

Apparatus Embodiment 1G1. The base station of Apparatus Embodiment 1, wherein a first timing-frequency structure for the first period of time includes more SBFD slots than non-SBFD UL slots, said first timing-frequency structure corresponding to the first timing-frequency structure information. (e.g., See FIG. 6)

Apparatus Embodiment 1G2. The base station of Apparatus Embodiment 1, wherein the timing-frequency structure for the first period of time includes the same number of SBFD slots as the number of non-SBFD UL slots (e.g., See FIG. 8, 9 or 10), said first timing-frequency structure corresponding to the first timing-frequency structure information.

Apparatus Embodiment 2. The base station of Apparatus Embodiment 1, wherein in the first timing-frequency structure information, the ROs in the non-SBFD slots and the ROs in the SBFD slots have an association period which is the same, a number of Synchronization Signal Blocks (SSBs) per RO (e.g., number of SSB indices mapped to an RO) is the same for both non-SBFD slots and SBFD slots, and an RO duration is the same for both non-SBFD and SBFD slots. (e.g., the non-SBFD and SBFD slots have the same association period, same number of SSBs per RO and same PRACH duration which is reflected in the ROs having the same duration).

Apparatus Embodiment 2A. The base station of Apparatus Embodiment 2 wherein, in the first timing-frequency structure information, the SSB to RO mapping is different for SBFD slots and non-SBFD slots.

Apparatus Embodiment 2B. The base station of Apparatus Embodiment 2A, wherein, in the first timing-frequency structure information, a first SSB (e.g., SSB1) maps to a first RO (e.g., RO1 624) in a non-SBFD slot (e.g., slot 624) and a second RO (e.g., RO1 632) in a SBFD slot (e.g., slot 612), said first RO corresponding to a first set of frequencies, said second RO corresponding to a second set of frequencies, said first set of frequencies being different than said first set of frequencies.

Apparatus Embodiment 3. The base station of Apparatus Embodiment 1, wherein in the first timing-frequency structure information, the ROs in the non-SBFD slots and the ROs in the SBFD slots have an association period which is the same for both non-SBFD slots and SBFD slots, an RO duration which is the same (e.g., the same PRACH format is used for ROs in SBFD slots and non-SBFD slots), but non-SBFD slots have a different number of SSBs per RO than SBFD slots.

Apparatus Embodiment 4. The base station of Apparatus Embodiment 1, wherein in the first timing-frequency structure information, the ROs in non-SBFD slots and ROs in SBFD slots have an association period which is the same, a number of SSBs per RO which is the same for both non-SBFD slots and SBFD slots, but different RO durations are used for non-SBFD slots and SBFD slots (e.g., non-SBFD slots and SBFD slots use different PRACH durations and/or formats).

Apparatus Embodiment 5. The base station of Apparatus Embodiment 1, wherein in the first timing-frequency structure information, the non-SBFD slots and SBFD slots have a number of SSBs per RO which is the same for both non-SBFD slots and SBFD slots, the non-SBFD slots and SBFD slots have a RO duration which is the same for both non-SBFD slots and SBFD slots (e.g., both non-SBFD and SBFD slots have the same PRACH duration), but the non-SBFD slots and SBFD slots have different association periods.

Apparatus Embodiment 5A. The base station of Apparatus Embodiment 5, wherein the non-SBFD slots have an association period of 10 ms while the SBFD slots have an association period of 20 ms.

Apparatus Embodiment 6. The base station of Apparatus Embodiment 1, wherein in the first timing-frequency structure information, the non-SBFD slots and SBFD slots have a different number of SSBs per RO, said non-SBFD slots having more SSBs mapped to an RO than the SBFD slots (e.g., 2 SSBs are mapped to each RO in a non-SBFD slot and 1 SSB is mapped to an RO in a SBFD slot), and SBFD slots have a RO duration which is the same for both non-SBFD slots and SBFD slots (e.g., both non-SBFD and SBFD slots have the same PRACH duration), but the non-SBFD slots and SBFD slots have different association periods. (See FIG. 10.)

Apparatus Embodiment 6A. The base station of Apparatus Embodiment 6, wherein the non-SBFD slots have an association period of 10 ms while the SBFD slots have an association period of 20 ms.

### Second Numbered List of Exemplary Method Embodiments

Method Embodiment 1. A method of operating a UE, the method comprising: receiving (1204) first timing-frequency structure information to be used for a first period of time (e.g. said first period of time including an association period corresponding to one or both non-SBFD and SBFD slots, with the first period of time being at least as long as the longer one of a non-SBFD and SBFD association periods if they are different so that the first period of time covers at least one non-SBFD association period and at least one SBFD association period), said first timing-frequency structure information indicating (e.g., timing and/or frequency location of ROs) RACH Occasions (ROs) in non-SBFD symbols (and slots) and SBFD symbols (and slots) (e.g., Random Access Channel Occasions (ROs) during which a UE can use a physical random access channel (PRACH) to send an access signal, e.g., a PRACH signal including a preamble) within a timing-frequency structure used by the base station; selecting (1220) one of the ROs indicated in the received information for use in transmitting a PRACH signal; and transmitting (1224) a PRACH signal on the selected RO.

Method Embodiment 1A0. The method of Method Embodiment 1, wherein the UE is a SBFD capable UE and wherein the selected RO corresponds to an SBFD slot.

Method Embodiment 1A. The method of Method Embodiment 1A0, wherein the first period of time includes at least one non-SBFD association period and at least one SBFD association period; and wherein the first timing-frequency structure information includes at least one set of SBFD timing-frequency structure information and at least one set of non-SBFD timing-frequency information.

Method Embodiment 1AA. The method of Method Embodiment 1A0, wherein the first timing-frequency structure information includes a different SSB-RO mapping for non-SBFD symbols and slots than an SSB-RO mapping for SBFD symbols and slots.

Method Embodiment 1AA1. The method of Method Embodiment 1AA, wherein said first timing-frequency structure information indicates that at least one SSB is mapped to a RO, using a first set of frequencies (e.g., a first set of 12 RBs, i.e. 144 subcarriers), in a non-SBFD slot and is mapped to a RO using a second set of frequencies (e.g., a second set of RBs, i.e. 144 subcarriers) in a SBFD slot, said first set of frequencies being different than said second set of frequencies.

Method Embodiment 1B. The method of Method Embodiment 1A, wherein SBFD symbols are included in SBFD slots; wherein non-SBFD symbols are included in non-SBFD slots; wherein the non-SBFD association period relates to a period of time in which information provided for ROs in non-SBFD symbols and slots is valid; and wherein the SBFD association period relates to a period of time in which information provided for ROs in SBFD symbols and slots is valid.

Method Embodiment 1BAA. The method of Method Embodiment 1B, wherein the non-SBFD association period and SBFD association period are the same during said first period of time.

Method Embodiment 1C. The method of Method Embodiment 1A0, further comprising: receiving, at the UE, (1204 second iteration) timing-frequency structure information to be used for an additional period of time (e.g. said additional period of time including an association period corresponding to one or both non-SBFD and SBFD slots, with the additional period of time being at least as long as the longer one of a non-SBFD and SBFD association periods if they are different so that the first period of time covers at least one non-SBFD association period and at least one SBFD association period), said timing-frequency structure information to be used for the additional period of time indicating (e.g., timing and/or frequency location of ROs) RACH Occasions (ROs) in non-SBFD symbols (and slots) and SBFD symbols (and slots) (e.g., Random Access Channel Occasions (ROs) during which a UE can use a physical random access channel (PRACH) to send an access signal, e.g., a PRACH signal including a preamble) within a timing-frequency structure used by the base station; selecting (1220 second iteration) one of the ROs indicated in the received information for the additional period of time use in transmitting a PRACH signal; and transmitting (1224) (second iteration) a PRACH signal on the selected RO.

Method Embodiment 1CA. The method of Method Embodiment 1C, wherein the non-SBFD association period duration and SBFD association period duration are different during said additional period of time.

Method Embodiment 1CB. The method of Method Embodiment 1C, wherein the non-SBFD association period is 10 ms and wherein the SBFD association period is 20 ms.

Method Embodiment 1D. The method of Method Embodiment 1C, wherein the timing-frequency structure to be used for the additional period of time was selected by the base station based (1120) on the number of UEs receiving service from the base station

Method Embodiment 1DA. The method of Method Embodiment 1C, wherein the first timing-frequency structure includes ROs in non-SBFD slots and ROs in SBFD slots have the same duration (FIG. 8) (e.g. a PRACH signal duration corresponding to, e.g., the duration of 12 OFDM symbols).

Method Embodiment 1D. The method of Method Embodiment 1C, wherein during the first period of time the SBFD and non-SBFD association periods are the same (FIG. 8); wherein the timing-frequency structure to be used for an additional period of time includes has an SBFD association period and a non-SBFD association period, said SBFD association period and non-SBFD association period being different in the timing-frequency structure to be used for an additional period of time; and wherein the SBFD association period is longer than the non-SBFD association period in the timing-frequency structure to be used for an additional period of time.

Method Embodiment 1E. The method of Method Embodiment 1C, wherein SBFD timing-frequency structure information is indicated separately from non-SBFD timing-frequency structure information in the received (1204 second iteration) timing-frequency structure information to be used for an additional period of time.

Method Embodiment 1G. The method of Method Embodiment 1A0, wherein a first timing-frequency structure for the first period of time includes more non-SBFD UL slots than SBFD slots and more downlink slots than SBFD slots, said first timing-frequency structure corresponding to the first timing-frequency structure information. (See FIG. 7)

Method Embodiment 1G1. The method of Method Embodiment 1A0, wherein a first timing-frequency structure for the first period of time includes more SBFD slots than non-SBFD UL slots, said first timing-frequency structure corresponding to the first timing-frequency structure information. (e.g., See FIG. 6)

Method Embodiment 1G2. The method of Method Embodiment 1A0, wherein the timing-frequency structure for the first period of time includes the same number of SBFD slots as the number of non-SBFD UL slots (e.g., See FIG. 8, 9 or 10), said first timing-frequency structure corresponding to the first timing-frequency structure information.

Method Embodiment 2. The method of Method Embodiment 1A0, wherein in the first timing-frequency structure information, the ROs in the non-SBFD slots and the ROs in the SBFD slots have an association period which is the same, a number of Synchronization Signal Blocks (SSBs) per RO (e.g., number of SSB indices mapped to an RO) is the same for both non-SBFD slots and SBFD slots, and an RO duration is the same for both non-SBFD and SBFD slots. (e.g., the non-SBFD and SBFD slots have the same association period, same number of SSBs per RO and same PRACH duration which is reflected in the ROs having the same duration).

Method Embodiment 2A. The method of Method Embodiment 2 wherein, in the first timing-frequency structure information, the SSB to RO mapping is different for SBFD slots and non-SBFD slots.

Method Embodiment 2B. The method of Method Embodiment 2A, wherein, in the first timing-frequency structure information, a first SSB (e.g., SSB1) maps to a first RO (e.g., RO1 624) in a non-SBFD slot (e.g., slot 624) and a second RO (e.g., RO1 632) in a SBFD slot (e.g., slot 612), said first RO corresponding to a first set of frequencies, said second RO corresponding to a second set of frequencies, said first set of frequencies being different than said first set of frequencies.

Method Embodiment 3. The method of Method Embodiment 1, wherein in the first timing-frequency structure information, the ROs in the non-SBFD slots and the ROs in the SBFD slots have an association period which is the same for both non-SBFD slots and SBFD slots, an RO duration which is the same (e.g., the same PRACH format is used for ROs in SBFD slots and non-SBFD slots), but non-SBFD slots have a different number of SSBs per RO than SBFD slots.

Method Embodiment 4. The method of Method Embodiment 1, wherein in the first timing-frequency structure information, the ROs in non-SBFD slots and ROs in SBFD slots have an association period which is the same, a number of SSBs per RO which is the same for both non-SBFD slots and SBFD slots, but different RO durations are used for non-SBFD slots and SBFD slots (e.g., non-SBFD slots and SBFD slots use different PRACH durations and/or formats).

Method Embodiment 5. The method of Method Embodiment 1, wherein in the first timing-frequency structure information, the non-SBFD slots and SBFD slots have a number of SSBs per RO which is the same for both non-SBFD slots and SBFD slots, the non-SBFD slots and SBFD slots have a RO duration which is the same for both non-SBFD slots and SBFD slots (e.g., both non-SBFD and SBFD slots have the same PRACH duration), but the non-SBFD slots and SBFD slots have different association periods.

Method Embodiment 5A. The method of Method Embodiment 5, wherein the non-SBFD slots have an association period of 10 ms while the SBFD slots have an association period of 20 ms.

Method Embodiment 6. The method of Method Embodiment 1, wherein in the first timing-frequency structure information, the non-SBFD slots and SBFD slots have a different number of SSBs per RO, said non-SBFD slots having more SSBs mapped to an RO than the SBFD slots (e.g., 2 SSBs are mapped to each RO in a non-SBFD slot and 1 SSB is mapped to an RO in a SBFD slot), and SBFD slots have a RO duration which is the same for both non-SBFD slots and SBFD slots (e.g., both non-SBFD and SBFD slots have the same PRACH duration), but the non-SBFD slots and SBFD slots have different association periods.

Method Embodiment 6A. The method of Method Embodiment 6, wherein the non-SBFD slots have an association period of 10 ms while the SBFD slots have an association period of 20 ms.

### Second Numbered List of Exemplary Apparatus Embodiments

Apparatus Embodiment 1. A user equipment (UE) (106, 108, 114, 116 or 300) comprising: memory (312); a transmitter (e.g., wireless transmitter 326); a receiver (e.g., wireless receiver 324); and a processor (302) configured to control the UE to: receive (1204) first timing-frequency structure information to be used for a first period of time (e.g. said first period of time including an association period corresponding to one or both non-SBFD and SBFD slots, with the first period of time being at least as long as the longer one of a non-SBFD and SBFD association periods if they are different so that the first period of time covers at least one non-SBFD association period and at least one SBFD association period), said first timing-frequency structure information indicating (e.g., timing and/or frequency location of ROs) RACH Occasions (ROs) in non-SBFD symbols (and slots) and SBFD symbols (and slots) (e.g., Random Access Channel Occasions (ROs) during which a UE can use a physical random access channel (PRACH) to send an access signal, e.g., a PRACH signal including a preamble) within a timing-frequency structure used by the base station; select (1220) one of the ROs indicated in the received information for use in transmitting a PRACH signal; and transmit (1224) a PRACH signal on the selected RO.

Apparatus Embodiment 1A0. The UE of Apparatus Embodiment 1, wherein the UE is a SBFD capable UE; and wherein the selected RO corresponds to an SBFD slot.

Apparatus Embodiment 1A. The UE of Apparatus Embodiment 1A0, wherein the first period of time includes at least one non-SBFD association period and at least one SBFD association period; and wherein the first timing-frequency structure information includes at least one set of SBFD timing-frequency structure information and at least one set of non-SBFD timing-frequency information.

Apparatus Embodiment 1AA. The UE of Apparatus Embodiment 1A0, wherein the first timing-frequency structure information includes a different SSB-RO mapping for non-SBFD symbols and slots than an SSB-RO mapping for SBFD symbols and slots.

Apparatus Embodiment 1AA1. The UE of Apparatus Embodiment 1AA, wherein said first timing-frequency structure information indicates that at least one SSB is mapped to a RO, using a first set of frequencies (e.g., a first set of 12 RBs, i.e. 144 subcarriers), in a non-SBFD slot and is mapped to a RO using a second set of frequencies (e.g., a second set of RBs, i.e. 144 subcarriers) in a SBFD slot, said first set of frequencies being different than said second set of frequencies.

Apparatus Embodiment 1B. The UE of Apparatus Embodiment 1A, wherein SBFD symbols are included in SBFD slots; wherein non-SBFD symbols are included in non-SBFD slots; wherein the non-SBFD association period relates to a period of time in which information provided for ROs in non-SBFD symbols and slots is valid; and wherein the SBFD association period relates to a period of time in which information provided for ROs in SBFD symbols and slots is valid.

Apparatus Embodiment 1BAA. The UE of Apparatus Embodiment 1B, wherein the non-SBFD association period and SBFD association period are the same during said first period of time.

Apparatus Embodiment 1C. The UE of Apparatus Embodiment 1A0, wherein the processor is further configured to control the UE to: receive, at the UE, (1204 second iteration) timing-frequency structure information to be used for an additional period of time (e.g. said additional period of time including an association period corresponding to one or both non-SBFD and SBFD slots, with the additional period of time being at least as long as the longer one of a non-SBFD and SBFD association periods if they are different so that the first period of time covers at least one non-SBFD association period and at least one SBFD association period), said timing-frequency structure information to be used for the additional period of time indicating (e.g., timing and/or frequency location of ROs) RACH Occasions (ROs) in non-SBFD symbols (and slots) and SBFD symbols (and slots) (e.g., Random Access Channel Occasions (ROs) during which a UE can use a physical random access channel (PRACH) to send an access signal, e.g., a PRACH signal including a preamble) within a timing-frequency structure used by the base station; select (1220 second iteration) one of the ROs indicated in the received information for the additional period of time use in transmitting a PRACH signal; and transmit (1224 (second iteration) a PRACH signal on the selected RO.

Apparatus Embodiment 1CA. The UE of Apparatus Embodiment 1C, wherein the non-SBFD association period duration and SBFD association period duration are different during said additional period of time.

Apparatus Embodiment 1CB. The UE of Apparatus Embodiment 1C, wherein the non-SBFD association period is 10 ms and wherein the SBFD association period is 20 ms.

Apparatus Embodiment 1D. The UE of Apparatus Embodiment 1C, wherein the timing-frequency structure to be used for the additional period of time was selected by the base station based (1120) on the number of UEs receiving service from the base station

Apparatus Embodiment 1DA. The UE of Apparatus Embodiment 1C, wherein the first timing-frequency structure includes ROs in non-SBFD slots and ROs in SBFD slots have the same duration (FIG. 8) (e.g. a PRACH signal duration corresponding to, e.g., the duration of 12 OFDM symbols).

Apparatus Embodiment 1D. The UE of Apparatus Embodiment 1C, wherein during the first period of time the SBFD and non-SBFD association periods are the same (FIG. 8); wherein the timing-frequency structure to be used for an additional period of time includes has an SBFD association period and a non-SBFD association period, said SBFD association period and non-SBFD association period being different in the timing-frequency structure to be used for an additional period of time; and wherein the SBFD association period is longer than the non-SBFD association period in the timing-frequency structure to be used for an additional period of time.

Apparatus Embodiment 1E. The UE of Apparatus Embodiment 1C, wherein SBFD timing-frequency structure information is indicated separately from non-SBFD timing-frequency structure information in the received (1204 second iteration) timing-frequency structure information to be used for an additional period of time.

Apparatus Embodiment 1G. The UE of Apparatus Embodiment 1A0, wherein a first timing-frequency structure for the first period of time includes more non-SBFD UL slots than SBFD slots and more downlink slots than SBFD slots, said first timing-frequency structure corresponding to the first timing-frequency structure information. (See FIG. 7)

Apparatus Embodiment 1G1. The UE of Apparatus Embodiment 1A0, wherein a first timing-frequency structure for the first period of time includes more SBFD slots than non-SBFD UL slots, said first timing-frequency structure corresponding to the first timing-frequency structure information. (e.g., See FIG. 6)

Apparatus Embodiment 1G2. The UE of Apparatus Embodiment 1A0, wherein the timing-frequency structure for the first period of time includes the same number of SBFD slots as the number of non-SBFD UL slots (e.g., See FIG. 8, 9 or 10), said first timing-frequency structure corresponding to the first timing-frequency structure information.

Apparatus Embodiment 2. The UE of Apparatus Embodiment 1A0, wherein in the first timing-frequency structure information, the ROs in the non-SBFD slots and the ROs in the SBFD slots have an association period which is the same, a number of Synchronization Signal Blocks (SSBs) per RO (e.g., number of SSB indices mapped to an RO) is the same for both non-SBFD slots and SBFD slots, and an RO duration is the same for both non-SBFD and SBFD slots. (e.g., the non-SBFD and SBFD slots have the same association period, same number of SSBs per RO and same PRACH duration which is reflected in the ROs having the same duration).

Apparatus Embodiment 2A. The UE of Apparatus Embodiment 2 wherein, in the first timing-frequency structure information, the SSB to RO mapping is different for SBFD slots and non-SBFD slots.

Apparatus Embodiment 2B. The UE of Apparatus Embodiment 2A, wherein, in the first timing-frequency structure information, a first SSB (e.g., SSB1) maps to a first RO (e.g., RO1 624) in a non-SBFD slot (e.g., slot 624) and a second RO (e.g., RO1 632) in a SBFD slot (e.g., slot 612), said first RO corresponding to a first set of frequencies, said second RO corresponding to a second set of frequencies, said first set of frequencies being different than said first set of frequencies.

Apparatus Embodiment 3. The UE of Apparatus Embodiment 1, wherein in the first timing-frequency structure information, the ROs in the non-SBFD slots and the ROs in the SBFD slots have an association period which is the same for both non-SBFD slots and SBFD slots, an RO duration which is the same (e.g., the same PRACH format is used for ROs in SBFD slots and non-SBFD slots), but non-SBFD slots have a different number of SSBs per RO than SBFD slots.

Apparatus Embodiment 4. The UE of Apparatus Embodiment 1, wherein in the first timing-frequency structure information, the ROs in non-SBFD slots and ROs in SBFD slots have an association period which is the same, a number of SSBs per RO which is the same for both non-SBFD slots and SBFD slots, but different RO durations are used for non-SBFD slots and SBFD slots (e.g., non-SBFD slots and SBFD slots use different PRACH durations and/or formats).

Apparatus Embodiment 5. The UE of Apparatus Embodiment 1, wherein in the first timing-frequency structure information, the non-SBFD slots and SBFD slots have a number of SSBs per RO which is the same for both non-SBFD slots and SBFD slots, the non-SBFD slots and SBFD slots have a RO duration which is the same for both non-SBFD slots and SBFD slots (e.g., both non-SBFD and SBFD slots have the same PRACH duration), but the non-SBFD slots and SBFD slots have different association periods.

Apparatus Embodiment 5A. The UE of Apparatus Embodiment 5, wherein the non-SBFD slots have an association period of 10 ms while the SBFD slots have an association period of 20 ms.

Apparatus Embodiment 6. The UE of Apparatus Embodiment 1, wherein in the first timing-frequency structure information, the non-SBFD slots and SBFD slots have a different number of SSBs per RO, said non-SBFD slots having more SSBs mapped to an RO than the SBFD slots (e.g., 2 SSBs are mapped to each RO in a non-SBFD slot and 1 SSB is mapped to an RO in a SBFD slot), and SBFD slots have a RO duration which is the same for both non-SBFD slots and SBFD slots (e.g., both non-SBFD and SBFD slots have the same PRACH duration), but the non-SBFD slots and SBFD slots have different association periods. (See, e.g., FIG. 10)

Apparatus Embodiment 6A. The UE of Apparatus Embodiment 6, wherein the non-SBFD slots have an association period of 10 ms while the SBFD slots have an association period of 20 ms.

The techniques of various embodiments may be implemented using software, hardware and/or a combination of software and hardware. Various embodiments are directed to apparatus, e.g., base stations, user equipment (UE) devices, core network devices (e.g., PCF devices, AMF devices, SMF devices, UPF devices, UDM devices, UDR devices, AUSF devices, etc.), access network devices (e.g., WLAN APs, base stations, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to methods, e.g., method of controlling and/or operating base stations, user equipment (UE) devices, core network devices (e.g., PCF devices, AMF devices, SMF devices, UPF devices, AUSF devices, UDM devices, UDR devics, etc.), access network devices (e.g., WLAN APs, base stations, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to a machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In various embodiments devices, e.g., base stations, user equipment (UE) devices, core network devices (e.g., PCF devices, AMF devices, SMF devices, UPF devices, UDM devices, UDR devices, AUSF devices, etc.), access network devices (e.g., base stations, WLAN APs, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements described herein are implemented using one or more components to perform the steps corresponding to one or more methods, for example, provisioning and/or configuring user equipment devices, provisioning and/or configuring AP devices, provisioning AAA servers, provisioning orchestration servers, generating messages, message reception, message transmission, signal processing, sending, comparing, determining and/or transmission steps. Thus, in some embodiments various features are implemented using components, or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., base stations, user (UE) devices, core network devices (e.g., PCF devices, AMF devices, SMF devices, UPF devices, AUSF devices, UDM devices, UDR devices, etc.), access network devices (e.g., base stations, WLAN APs, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, are configured to perform the steps of the methods described as being performed by the base stations, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., a base station, a user equipment (UE) device, core network device (e.g., PCF device, AMF device, SMF device, UPF device, AUSF device, UDM device, UDR device, etc.), access network device (e.g., base station, WLAN AP, WiFi access node, cable network access device), wireless device, mobile device, smartphone, subscriber device, desktop computer, printer, IPTV, laptop, tablet, network edge device, Access Point, wireless router, switch, WLAN controller, orchestration server, orchestrator, Gateway, AAA server, server, node and/or element, with a processor which includes a component corresponding to each of the steps of the various described methods performed by the device in which the processor is included. In some but not all embodiments a device, e.g., a base station, a user equipment (UE) device, core network devices (e.g., PCF devices, AMF devices, SMF devices, UPF devices, AUSF devices, UDM devices, UDR devices, etc.), access network devices (e.g., base stations, WLAN APs, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., a base station, a user equipment (UE) device, core network device (e.g., PCF device, AMF device, SMF device, UPF device, AUSF device, UDM device, UDR device, etc.), access network device (e.g., base station, WLAN AP, WiFi access node, cable network access device), wireless device, mobile device, smartphone, subscriber device, desktop computer, printer, IPTV, laptop, tablet, network edge device, Access Point, wireless router, switch, WLAN controller, orchestration server, orchestrator, Gateway, AAA server, server, nodes and/or element. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as a base station, a user equipment (UE) device, core network device (e.g., PCF device, AMF device, SMF device, UPF device, AUSF device, UDM device, UDR device, etc.), access network device (e.g., base station, WLAN AP, WiFi access node, cable network access device), wireless device, mobile device, smartphone, subscriber device, desktop computer, printer, IPTV, laptop, tablets, network edge device, Access Point, wireless router, switch, WLAN controller, orchestration server, orchestrator, Gateway, AAA server, server, node and/or element or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of operating a base station, the method comprising:
transmitting first timing-frequency structure information to be used for a first period of time, said first timing-frequency structure information indicating RACH Occasions (ROs) in non-SBFD symbols and SBFD symbols within a timing-frequency structure used by the base station; and
monitoring for physical random access channel (PRACH) signals from user equipments (UEs) being communicated on ROs included in the non-sub-band full duplex (non-SBFD) symbols and sub-band full duplex (SBFD) symbols.

2. The method of claim 1, wherein the first period of time includes at least one non-SBFD association period and at least one SBFD association period; and
wherein the first timing-frequency structure information includes at least one set of SBFD timing-frequency structure information and at least one set of non-SBFD timing-frequency information.

3. The method of claim 1,
wherein the first timing-frequency structure information includes a different SSB-RO mapping for non-SBFD symbols and slots than an SSB-RO mapping for SBFD symbols and slots; and
wherein said first timing-frequency structure information indicates that at least one SSB is mapped to a RO, using a first set of frequencies, in a non-SBFD slot and is mapped to a RO using a second set of frequencies in a SBFD slot, said first set of frequencies being different than said second set of frequencies.

4. The method of claim 1, further comprising:
selecting a timing-frequency structure to be used for an additional period of time, said timing-frequency structure to be used for the additional period of time being a timing-frequency structure which is the same or different than the first timing-frequency structure; and
transmitting information indicating the selected timing-frequency structure to be used during the additional period of time.

5. The method of claim 4, wherein the non-SBFD association period duration and SBFD association period duration are different during said additional period of time.

6. The method of claim 4, wherein selecting the timing-frequency structure to be used for the additional period of time is based on the number of UEs receiving service from the base station.

7. The method of claim 6,
wherein the first timing-frequency structure includes ROs in non-SBFD slots and ROs in SBFD slots have the same duration.

8. The method of claim 7,
wherein selecting the timing-frequency structure to be used for the additional period of time includes selecting, in response to an increase in the number of SBFD capable UEs being served by the base station since the first timing-frequency structure was selected, a timing-frequency structure which maps multiple SSBs to an RO in an SBFD slot and maps a single SSB to an RO in non-SBFD slots.

9. The method of claim 7,
wherein selecting the timing-frequency structure to be used for the additional period of time includes selecting, a timing-frequency structure to be used for the additional period of time, a timing-frequency structure which maps a first number of SSBs to a RO for SBFD slots and a second number of SSBs to a RO for non-SBFD slots, said first number being different than said second number.

10. The method of claim 1, wherein in the first timing-frequency structure information, the ROs in the non-SBFD slots and the ROs in the SBFD slots have an association period which is the same, a number of Synchronization Signal Blocks (SSBs) per RO is the same for both non-SBFD slots and SBFD slots, and an RO duration is the same for both non-SBFD and SBFD slots.

11. The method of claim 1, wherein in the first timing-frequency structure information, the ROs in the non-SBFD slots and the ROs in the SBFD slots have an association period which is the same for both non-SBFD slots and SBFD slots, an RO duration which is the same (e.g., the same PRACH format is used for ROs in SBFD slots and non-SBFD slots), but non-SBFD slots have a different number of SSBs per RO than SBFD slots.

12. The method of claim 1, wherein in the first timing-frequency structure information, the ROs in non-SBFD slots and ROs in SBFD slots have an association period which is the same, a number of SSBs per RO which is the same for both non-SBFD slots and SBFD slots, but different RO durations are used for non-SBFD slots and SBFD slots.

13. The method of claim 1, wherein in the first timing-frequency structure information, the non-SBFD slots and SBFD slots have a number of SSBs per RO which is the same for both non-SBFD slots and SBFD slots, the non-SBFD slots and SBFD slots have a RO duration which is the same for both non-SBFD slots and SBFD slots, but the non-SBFD slots and SBFD slots have different association periods.

14. The method of claim 1, wherein in the first timing-frequency structure information, the non-SBFD slots and SBFD slots have a different number of SSBs per RO, said non-SBFD slots having more SSBs mapped to an RO than the SBFD slots, and SBFD slots have a RO duration which is the same for both non-SBFD slots and SBFD slots, but the non-SBFD slots and SBFD slots have different association periods.

15. A base station, comprising:
memory storing timing-frequency structure information;
a transmitter;
a receiver; and
a processor configured to control the base station to:
transmit first timing-frequency structure information to be used for a first period of time, said first timing-frequency structure information indicating Random Access Channel (RACH) Occasions (ROs) in non-sub-band full duplex (non-SBFD) symbols and sub-band full duplex (SBFD) symbols within a timing-frequency structure used by the base station; and
monitor for physical random access channel (PRACH) signals from user equipments (UEs) being communicated on ROs included in the non-SBFD and SBFD symbols.

16. The base station of claim 15, wherein the first period of time includes at least one non-SBFD association period and at least one SBFD association period; and
wherein the first timing-frequency structure information includes at least one set of SBFD timing-frequency structure information and at least one set of non-SBFD timing-frequency information.

17. The base station of claim 15,
wherein the first timing-frequency structure information includes a different SSB-RO mapping for non-SBFD symbols and slots than an SSB-RO mapping for SBFD symbols and slots; and
wherein said first timing-frequency structure information indicates that at least one SSB is mapped to a RO, using a first set of frequencies, in a non-SBFD slot and is mapped to a RO using a second set of frequencies in a SBFD slot, said first set of frequencies being different than said second set of frequencies.

18. A method of operating user equipment (UE), the method comprising:
receiving first timing-frequency structure information to be used for a first period of time, said first timing-frequency structure information indicating random access channel occasions (ROs) in non-sub-band full duplex (non-SBFD) symbols and sub-band full duplex (SBFD) symbols within a timing-frequency structure used by the base station;
selecting one of the ROs indicated in the received information for use in transmitting a physical random access channel (PRACH) signal; and
transmitting the PRACH signal on the selected RO.

19. The method of claim 18, wherein the UE is a SBFD capable UE and wherein the selected RO corresponds to an SBFD slot.

20. The method of claim 19,
wherein the first period of time includes at least one non-SBFD association period and at least one SBFD association period; and
wherein the first timing-frequency structure information includes at least one set of SBFD timing-frequency structure information and at least one set of non-SBFD timing-frequency information.

21. The method of claim 19, further comprising:
receiving, at the UE, timing-frequency structure information to be used for an additional period of time, said timing-frequency structure information to be used for the additional period of time indicating RACH Occasions (ROs) in non-SBFD symbols and SBFD symbols within a timing-frequency structure used by the base station;
selecting one of the ROs indicated in the received information for the additional period of time use in transmitting a PRACH signal; and
transmitting a PRACH signal on the selected RO.

22. The method of claim 19, wherein in the first timing-frequency structure information, the ROs in the non-SBFD slots and the ROs in the SBFD slots have an association period which is the same, a number of Synchronization Signal Blocks (SSBs) per RO is the same for both non-SBFD slots and SBFD slots, and an RO duration is the same for both non-SBFD and SBFD slots.

23. The method of claim 18, wherein in the first timing-frequency structure information, the ROs in the non-SBFD slots and the ROs in the SBFD slots have an association period which is the same for both non-SBFD slots and SBFD slots, an RO duration which is the same (e.g., the same PRACH format is used for ROs in SBFD slots and non-SBFD slots), but non-SBFD slots have a different number of SSBs per RO than SBFD slots.

24. The method of claim 18, wherein in the first timing-frequency structure information, the ROs in non-SBFD slots and ROs in SBFD slots have an association period which is the same, a number of SSBs per RO which is the same for both non-SBFD slots and SBFD slots, but different RO durations are used for non-SBFD slots and SBFD slots.

25. The method of claim 18, wherein in the first timing-frequency structure information, the non-SBFD slots and SBFD slots have a number of SSBs per RO which is the same for both non-SBFD slots and SBFD slots, the non-SBFD slots and SBFD slots have a RO duration which is the same for both non-SBFD slots and SBFD slots (e.g., both non-SBFD and SBFD slots have the same PRACH duration), but the non-SBFD slots and SBFD slots have different association periods.

26. The method of claim 25, wherein the non-SBFD slots have an association period of 10 ms while the SBFD slots have an association period of 20 ms.

27. The method of claim 18, wherein in the first timing-frequency structure information, the non-SBFD slots and SBFD slots have a different number of SSBs per RO, said non-SBFD slots having more SSBs mapped to an RO than the SBFD slots, ROs have a duration which is the same for both non-SBFD slots and SBFD slots, but the non-SBFD slots and SBFD slots have different association periods.

28. A user equipment (UE) comprising:
memory;
a transmitter;
a receiver; and
a processor configured to control the UE to:
receive first timing-frequency structure information to be used for a first period of time, said first timing-frequency structure information indicating RACH Occasions (ROs) in non-sub-band full duplex (non-SBFD) symbols and sub-band full duplex (SBFD) symbols during which a UE can use a physical random access channel (PRACH) to send an access signal within a timing-frequency structure used by the base station;
select one of the ROs indicated in the received information for use in transmitting a PRACH signal; and
transmit a PRACH signal on the selected RO.

29. The UE of claim 28, wherein the UE is a SBFD capable UE and wherein the selected RO corresponds to an SBFD slot.

30. The UE of claim 29,
wherein the first period of time includes at least one non-SBFD association period and at least one SBFD association period; and
wherein the first timing-frequency structure information includes at least one set of SBFD timing-frequency structure information and at least one set of non-SBFD timing-frequency information.
